(19) United States
(12) Patent Application Publication
(10) Pub. No.: US 2011/0191234 A1
(43) Pub. Date: Aug. 4, 2011

(54) Securitization System and Process

(76) Inventor: Kenneth Kiron, Teaneck, NJ (US)

(21) Appl. No.: 13/019,936

(22) Filed: Feb. 2, 2011

Related U.S. Application Data
(60) Provisional application No. 61/300,505, filed on Feb. 2, 2010.
(60) Provisional application No. 61/311,910, filed on Mar. 9, 2010.
(60) Provisional application No. 61/314,832, filed on Mar. 17, 2010.
(60) Provisional application No. 61/355,715, filed on Jun. 17, 2010.

(51) Int. Cl. G06Q 40/00; G06Q 90/00

(52) U.S. Cl. 705/37; 705/35; 705/500

(57) ABSTRACT

A system and process is disclosed for providing a financial product having a return correlated to a benchmark with a reduced tracking error over time.

### CROSS-REFERENCE TO RELATED APPLICATIONS

This application claims the benefit of U.S. provisional patent application Ser. Nos.: 61/300,505, filed Feb. 2, 2010; 61/311,910, filed Mar. 9, 2010; 61/314,832, filed Mar. 17, 2010; and, 61/355,715, filed Jun. 17, 2010.

This application also incorporates by reference U.S. Pat. No. 7,698,192 to Kiron, issued on Apr. 13, 2010.

### TECHNICAL FIELD OF THE INVENTION

The present invention relates to reducing the tracking error of an exchange traded product such as an Exchange Traded Fund (ETF) or note.

### BACKGROUND OF THE INVENTION

Both Leveraged and Inverse Exchange Traded Products (including, but not limited to those structured as Exchange Traded Funds and Notes) are complex financial instruments that are typically designed to achieve their stated investment performance objectives on either a daily, monthly or lifetime basis. Due to the effects of compounding, their performance over longer periods of time can differ significantly from their stated daily objective. Because of this, FINRA (the Financial Industry Regulatory Authority), stated in a Jun. 2 2009 regulatory notice that “inverse and leveraged ETFs that are reset daily typically are unsuitable for retail investors who plan to hold them for longer than one trading session, particularly in volatile markets.” The impact of this notice on the industry has been swift and dramatic. At least one brokerage firm has banned these products outright and others have imposed limitations on how and when their retail clients can trade them.

As FINRA states, “ETFs are typically registered unit investment trusts (UITs) or open-end investment companies whose shares represent an interest in a portfolio of securities that track an underlying benchmark or index.” However, some ETFs that invest in commodities, currencies, or commodity- or currency-based instruments are not registered as investment companies. Leveraged ETFs seek to deliver multiples of the performance of the index or benchmark they track. Some leveraged ETFs are “inverse” or “short” funds, meaning that they seek to deliver the opposite of the performance of the index or benchmark they track. Like traditional ETFs, some inverse ETFs track broad indices, some are sector-specific, and still others are linked to commodities or currencies. Inverse ETFs are often marketed as a way for investors to profit from, or at least hedge their exposure to, downward moving markets. Some funds are both short and leveraged, meaning that they seek to achieve a return that is a multiple of the inverse performance of the underlying index. An inverse ETF that tracks the S&P 500, for example, seeks to deliver the inverse of the performance of the S&P 500, while a 2× leveraged inverse S&P 500 ETF seeks to deliver twice the opposite of that index's performance. To accomplish their objectives, leveraged and inverse ETFs pursue a range of investment strategies through the use of swaps, futures contracts and other derivative instruments. Most leveraged and inverse ETFs “reset” daily, meaning that they are designed to achieve their stated objectives on a daily basis. Due to the effect of compounding, their performance over longer periods of time can differ significantly from the performance (or inverse of the performance) of their underlying index or benchmark during the same period of time.

For example, between Dec. 1, 2008, and Apr. 30, 2009, the Dow Jones U.S. Oil & Gas Index gained 2 percent, while an ETF seeking to deliver twice the index's daily return fell 6 percent and the related ETF seeking to deliver twice the inverse of the index's daily return fell 26 percent. An ETF seeking to deliver three times the daily return of the Russell 1000 Financial Services Index fell 53 percent while the index actually gained around 8 percent. The related ETF seeking to deliver three times the inverse of the index's daily return declined by 90 percent over the same period. This effect can be magnified in volatile markets. Using a two-day example, if the index goes from 100 to close at 101 on the first day and back down to close at 100 on the next day, the two-day return of an inverse ETF will be different than if the index had moved up to close at 110 the first day but then back down to close at 100 on the next day. In the first case with low volatility, the inverse ETF loses 0.02 percent; but in the more volatile scenario the inverse ETF loses 1.82 percent. The effects of mathematical compounding can grow significantly over time, leading to scenarios such as those noted above.

As a result of the substantial tracking error which occurs over more than one day (due to daily mathematical compounding), there has been a significant industry backlash against daily resetting leveraged ETFs. For instance, on Jul. 27, 2009, UBS stated that it would not trade ETFs that use leverage. Ameriprise Financial and LPL Investment Holdings Inc. have also prohibited sales of leveraged ETFs that seek more than twice the long or short performance of their target index.

In an effort to mitigate the daily compounding effect associated with daily resetting leveraged and inverse leveraged ETFs, Fund Sponsors have recently introduced monthly resetting leveraged and inverse leveraged ETFs, which seek to deliver leveraged results over the course of a month. For example, if the index underlying a monthly 2× fund gained 10% in January, the leveraged products would be expected to gain 20% over the same time period. These returns would be generated regardless of the path taken by the underlying index during the month—but only if an investor bought the product on the IPO date and sold on the month end date. If the investor held the product through February however, he would not be expected to receive the total return of the index from January through the end of February. Rather, he would receive the compounded return of the January return and February return—not the sum of the two. The investor would have to sell part of his profits at the end of each month to avoid a compounding effect, or buy more if it went down, to avoid a decompounding effect. This performance return profile exists because the ETP is rebalanced monthly, (causing a compounding effect to occur) which prevents investors from matching the quarterly or yearly performance of the index. In addition, because the exposure is reset only once per month, the effective daily leverage of the product will deviate from the target multiple between resets for subsequent investors.

In addition to daily and monthly resetting leveraged products, there is currently a third category of leveraged products offering “lifetime” fixed leverage—fixed leverage for the life of the product. The product, offered by Barclays, is structured as an ETN and provides a mechanism for fixed leveraged exposure to an underlying index without the price path-dependency and compounding concerns of daily-reset or monthly-reset leveraged ETFs —but like the monthly-reset products, only if you buy on the IPO date. After the IPO date, subsequent investors will be subject to daily leverage “drift” as the leverage will change in response to the underlying Index. After the IPO date, unless the index remains unchanged, new investors will not receive the original leverage offered. The leverage may in fact be substantially less or more than the leverage initially offered.

However, in summary, daily resetting leveraged ETPs suffer from price path dependency and tracking errors for investors who buy and hold them for more than a day. Monthly resetting ETPs generate tracking errors when held for more than one month due to monthly rebalancing and suffer from leverage drift when purchased intra-month. Lifetime leverage products suffer from leverage drift when purchased at any time after the IPO date (unless the index is unchanged from the IPO date).

Currently, all of the existing daily, monthly and lifetime leveraged and inverse ETPs and linked products presently available (collectively representing over $40 Billion in assets under management) suffer a number of disadvantages for investors who wish to receive fixed point to point leverage, including:

A) Daily Leveraged and Inverse ETPs suffer from tracking errors caused by price path dependency.

B) Daily Leveraged and Inverse ETPs require investors to perform multiple steps on a daily basis to overcome price path dependency, including: At the end of each trading day, investors must determine what their gains and losses are; then if they have a gain, investors are forced to sell a portion of their portfolio so that their gains are not compounded. The disadvantage is a daily tax impact. As the investment is not held more than one year, it is subject to high short term capital gains treatment. In addition, commission expenses are incurred which increase trading costs. If they have a loss at the end of the day, investors must invest more capital to maintain fixed leverage. The disadvantage here is that investors may not have more capital to invest. In addition, they have to incur additional commission expenses which increase trading costs. Investors may not have the time or expertise to develop algorithms to automate this end of day process or to manually perform the needed calculations to avoid price path dependency. In addition, the bid/ask spreads required to continually enter and exit the positions at the end of each day will cause further tracking error over time.

C) Daily Leveraged and Inverse ETP investors can lose a substantial portion of their capital, even if they guess right about the direction of the market.

D) Daily Leveraged and Inverse ETP Investors cannot use the products as an unmanaged fixed hedge against their investments without the risk of substantial tracking error.

E) Investors cannot anticipate the correlation of daily leveraged ETP return against an underlying benchmark or index over time.

F) Monthly Leveraged and Inverse ETPs suffer from Leverage drift after the IPO date and tracking error if held for more than one month.

G) Lifetime Leverage and Inverse ETPs suffer from leverage drift after the IPO date.

H) Lifetime Leverage and Inverse ETPs cannot determine for their future investors in advance what their leverage exposure will be for an underlying benchmark or index on any given day.

I) Multiple brokerage firms will not allow their retail clients to trade Leveraged ETPs because of the price path dependency issue.

J) Due to the price path dependency problem, the Securities & Exchange Commission issued a directive in 2010 freezing the approval of new exemptive relief applications for new Leveraged Exchange Traded Funds, preventing new ETF products from being approved until further notice.

### SUMMARY OF THE INVENTION

In an embodiment, the present invention improves upon the existing methodologies employed by leverage and inverse Exchange Traded Funds (ETF) and Exchange Traded Notes (ETN) sponsors and issuers to correlate returns to a benchmark or index by producing a non-price path dependent financial product that has no tracking error and which provides a statistically significant and greater degree of accuracy in tracking a benchmark or index over a period of one day or longer. Specifically, in an embodiment in accordance with the present invention, an exchange traded product, the preferred embodiment being an ETF, is created whereby it has a daily mandatory exchange feature that exchanges shares of the ETF daily into two separate ETFs, each of which has a defined start of day leverage level and price. The ETF exchanges the shares held by investors after the close of business each day into a preferred combination of shares in the two separate ETFs. The preferred combination provides investors with a combined weighted average leverage of a determined amount which will be fixed for as long as Investors hold the two securities. The two securities will also be exchange traded and can be bought or sold separately or in combination during the trading day. In addition, to enhance liquidity and fungibility as well as to facilitate arbitrage, in an embodiment the ETF sponsor has the ability to accept a pre-defined percentage (from 0 to 100%) of underlying nominal of a group of one or more securities comprising the benchmark or index as part of the sponsor creation/redemption process and to provide the ability to create and redeem not only daily but also in real-time or intra-day. Other structures can also be considered besides an ETF, including a debt instrument (such as an ETN), a trust (grantor, business or unit), a commodity pool that is exchange traded, or other defined product structure. Linked Derivatives (including but not limited to single share futures, index futures, commodity futures, structured products, options, swaps, warrants) can then be listed and traded on the product. In addition, off exchange products can be created in the form of mutual funds (either closed end or open end).

In another embodiment, a system is provided for creating an exchange traded product having a daily exchange feature. The system includes a computer memory comprising a set of defined criteria and a computer database containing data representing characteristics of a plurality of securities. The system also includes a processor for calculating at least an end of day weighting ratio derived from the securities based upon market capitalization contained in the database, the processor weighting the selected securities within the exchange traded product based on a set of defined weighting ratio criteria. Moreover, the exchange traded product is configured for trading of shares of the exchange traded product at a real-time determined price of the shares related to an underlying price of each of the selected securities comprising the exchange traded product and related to the weightings of the selected securities. Furthermore, the exchange traded product exchanges its market capitalization on at least a daily basis into two separate securities based upon a defined weighting ratio, the two separate securities comprising a majority of the market capitalization of the exchange traded product.

In yet another embodiment, a system is provided for creating a non-exchange traded product having a daily exchange feature. The system includes a computer memory comprising a set of defined criteria and a computer database containing data representing characteristics of a plurality of securities. The system also includes a processor for calculating at least an end of day weighting ratio derived from the securities based upon market capitalization contained in the database, the processor weighting the selected securities within the exchange traded product based on a set of defined weighting ratio criteria. In addition, the non-exchange traded product is configured for trading of shares of the non-exchange traded product at a determined price of the shares related to the underlying price of each of the selected securities comprising the non-exchange traded product and related to the respective weightings of the selected securities. Furthermore, the non-exchange traded product exchanges its market capitalization on at least a daily basis into two related securities based upon a defined weighting ratio, the two related securities comprising a majority of the market capitalization of the exchange traded product.

In still yet another embodiment, a system is provided for creating a leveraged exchange traded product having a daily exchange feature. The system includes a computer memory comprising a set of defined criteria and a computer database containing data representing characteristics of a plurality of securities. The system also includes a processor for calculating at least an end of day weighting ratio derived from the securities based upon the market capitalization contained in the database, the processor weighting the selected securities within the exchange traded product based on a set of defined weighting ratio criteria. In addition, the leveraged exchange traded product is configured for trading of shares of the exchange traded product at a determined price of the shares related to the underlying price of each of the selected securities comprising the leveraged exchange traded product and related to the respective weightings of the selected securities. Furthermore, the leveraged exchange traded product exchanges its market capitalization on at least a daily basis into two related securities based upon a defined weighting ratio, the two related securities comprising the majority of the market capitalization of the leveraged exchange traded product.

In another embodiment, a process is provided for administering a transformation of an exchange traded single product into two or more separate exchange traded single products on a daily basis. The process includes the steps of: (a) recording issuance of shares by a single exchange traded product bought from and redeemed with the single exchange traded product at a net asset value on a daily basis; (b) recording a daily automatic redemption of the majority of shares by the single exchange traded product that are listed for trading on a securities exchange and that are bought and sold at negotiated market prices; (c) calculating a leverage weighting solution on at least a daily basis; (d) recording issuance of shares by the second and third exchange traded product comprising a combined market capitalization substantially equivalent to the market capitalization of the single exchange traded product and which incorporates a leverage weighting solution; (e) maintaining account data of the outstanding shares of each exchange traded product, wherein an owner of any share has an undivided interest in one or more of the exchange traded products.

In a further embodiment, an apparatus is provided for valuing two component securities temporally decomposed from a single investable security. The apparatus includes an input device converting input leverage data representing the single investable security into input signals representing the input data; The apparatus also includes a computer having a processor, the processor connected to receive the input signals, the processor programmed to change the input signals to produce modified signals representing a separate market-based valuation of each of a plurality of components temporally decomposed from the single investable security, the components including a first component security containing a starting leverage factor less than a target leverage amount and a second component security containing a starting leverage factor greater than a target leverage amount. The apparatus further includes an output device connected to the processor converting the modified signals into documentation including the respective valuation, price, market capitalization and leverage weighting factor of each of the components.

In yet another embodiment, a system is provided of buying or selling in combination two securities that have a linked stop loss feature. The system includes a first security providing a price derived leverage amount below a target amount. The system also includes a second security providing a price derived leverage amount above a target amount. In addition, the two securities comprising a daily creation or redemption basket from a single ticker exchange traded fund. Furthermore, the two securities are capable of providing the same leverage as the single ticket exchange traded fund on a continuous non-disrupted time period.

In a further embodiment, a method is provided of distributing closing shareholder positions and ownership records of a first leveraged exchange traded fund into a pair of two separate products on a daily basis. The method includes the steps of: (a) notifying a custodian of security position changes; (b) notifying a transfer agent of shareholder record changes; and (c) distributing a closing market capitalization of the first fund to shareholders of record of the first fund for securities in the pair of said second and third products that provide in combination a non-price path dependent return with no leverage drift or compounding.

In another embodiment, a system is provided for creating a leveraged exchange traded product having a daily allocation and distribution feature. The system includes a computer memory comprising a set of defined criteria and a computer database containing data representing characteristics of a plurality of securities. The system also includes a processor for calculating at least an end of day weighting ratio derived from the securities based upon the market capitalization contained in the database, the processor weighting the selected securities within the exchange traded product based on a set of defined weighting ratio criteria. In addition, the leveraged exchange traded product is configured for trading of shares of the exchange traded product at a determined price of the shares related to the underlying price of each of the selected securities comprising the leveraged exchange traded product and related to the respective weightings of the selected securities. Furthermore, the leveraged exchange traded product allocates and distributes its market capitalization on at least a daily basis into two related securities based upon a defined weighting ratio, the two related securities comprising the majority of the market capitalization of the leveraged exchange traded product.

In still yet another embodiment, a computer implemented system is provided for exchanging shares in an exchange traded product. The system includes a display for displaying data representing shares of an exchange traded product comprising a leveraged portfolio of securities satisfying market capitalization criteria, the securities within the portfolio being weighted and having an expected return that is both greater than, and less than, the desired expected return of the exchange traded product, wherein the leveraged exchange traded product is configured for trading shares of the leveraged exchange traded product at a determined price of the shares related to the underlying price of each of the selected securities comprising the leveraged exchange traded product and related to the respective weightings of the selected securities. The system also includes an exchange computer for processing the exchange of the shares at a price related to the price of the securities within the leveraged portfolio.

In a further embodiment, a computer implemented system is provided for exchanging shares in a leveraged exchange traded product, the product incorporating both a minimum and maximum threshold level of eligible closing end of day market capitalization to be transferred daily to a predetermined number of related securities having a similar legal structure to the product. The system includes a display for displaying data representing shares of an exchange traded product comprising a leveraged portfolio of securities satisfying market capitalization and leverage criteria, one or more of the securities within the portfolio being weighted and having an expected return that is both greater than, and or less than, the desired expected return of the exchange traded product, wherein the leveraged exchange traded product is configured for trading shares of the leveraged exchange traded product at a determined price of the shares related to the underlying price of each of the selected securities comprising the leveraged exchange traded product and related to the respective weightings of the selected securities. The system also includes an exchange computer for processing the exchange of the shares at a price related to the price of the securities within the leveraged portfolio.

In another embodiment, a system is provided for creating a leveraged exchange traded product having a mandatory daily redemption feature. The system includes a computer memory comprising a set of defined criteria and a computer database containing data representing characteristics of a plurality of securities. The system also includes a processor for calculating at least an end of day weighting and leverage ratio derived from the securities based upon the market capitalization contained in the database, the processor weighting the selected securities within the exchange traded product based on a set of defined weighting ratio criteria. Moreover, the leveraged exchange traded product is configured for trading of shares of the exchange traded product at a determined price of the shares related to the underlying price of each of the selected securities comprising the leveraged exchange traded product and related to the respective weightings of the selected securities. Furthermore, the leveraged exchange traded product redeems its market capitalization on at least a daily basis into a predetermined pair of related securities based upon a defined weighting and leverage ratio, the pair of related securities comprising the majority of the market capitalization of the leveraged exchange traded product and having the same legal structure as the product.

These and other features and advantages of the invention will be more readily apparent upon reading the following description of the preferred embodiment of the invention and upon reference to the accompanying drawings wherein:

### BRIEF DESCRIPTION OF THE DRAWINGS

The present invention will be more fully understood by reference to the following detailed description thereof when read in conjunction with the attached drawings and wherein:

FIG. 1 is a table depicting the relationship between index levels and delta ratios;

FIG. 2 is a chart depicting the relationship between index levels and delta ratios;

FIG. 3 is a table depicting an exemplary embodiment of a pair of leveraged products having different leverage ratios;

FIG. 4A represents how the preferred embodiment of an ETF with a mandatory daily redemption feature, when held through the close of business, automatically redeems into two separate ETFs that are already listed on the Exchange and trading; the first ETF being unleveraged and providing a 1× return to an index, the second being a leveraged ETF and providing 3× the total return to an index; the two funds above in combination providing a weighted average leverage of 2 (for example) that is fixed for as long as the investor holds the two ETF positions;

FIGS. 4B, 4C and 4D represent a further embodiment, an allocation of capital between products over a two day time period is provided;

FIGS. 5A, 5B provide examples of the changing weighting and leverage of both products XXB & XXA an example Index moves UP over time. In FIG. 5C an example is provided where the Index has moved above a threshold level where at least one of the initial securities (XXB) has a market price derived leverage below the target leverage level (in this example 2) and two new securities (XXC & XXD) are created. Stated another way, in FIG. 5C, a scenario is presented where the example Index has moved above a threshold level which causes both XXB and XXA to each have a a market price derived leverage below the target leverage level and in FIG. 5D the reaction by the ETP sponsor to create two new securities (XXC & XXD);

FIGS. 6A, 6B, 6C show in an embodiment how an electronic order entering/execution/trade processing tool could be created that would provide the ability to quickly and easily close out the securities received by an investor who holds XX for more than one day;

FIG. 7 shows how a non exchange traded mutual fund would manage investor capital by investing in either an exchanged or non exchange traded version of XXA and XXB product;

FIGS. 8A, 8B, 8C, 8D shows how a Fund sponsor would create and manage XX, XXA and XXB in conjunction with a clearing, custodian and portfolio management system; and,

FIG. 9 depicts how a Fund sponsor would create and manage XX, XXA and XXB in conjunction with a real-time or intra-day creation/redemption by acting as a direct dealer or market maker. This process, in contrast to the current end of day process, could apply to both leveraged and unleveraged ETPs.

While the invention is susceptible of various modifications and alternative constructions, certain illustrated embodiments hereof have been shown in the drawings and will be described below. It should be understood, however, that there is no intention to limit the invention to the specific forms disclosed, but, on the contrary, the invention is to cover all modifications, alternative constructions and equivalents falling within the spirit and scope of the invention as defined by the appended claims.

### DETAILED DESCRIPTION OF THE INVENTION

The presently disclosed inventive system and method of reducing tracking error in leveraged ETPs allows investors to receive an investment return that provides: (a) fixed point to point leverage over any time period with no price path dependency for any benchmark or index; (b) fixed point to point leverage over any time period with no leverage drift for any benchmark of index; (c) a constant daily fixed leverage to a benchmark or index without the need to actively manage a portfolio's daily exposure once the position is established; (d) a ‘set and forget’ passively managed leveraged product that incurs relatively little trading costs compared to existing products to maintain the opening position leverage; and, (e) an effective hedge.

This process is made possible by a mandatory redemption feature that transforms the position held in a leveraged ETP at the end of the day into two (or more) separate ETPs. Specifically, in an embodiment in accordance with the present invention, an exchange traded product, the preferred embodiment being an ETF, is created whereby it has a daily mandatory exchange feature that exchanges units of the ETF daily into two separate ETFs, each of which has a defined start of day leverage level and price. The ETF exchanges the market capitalization of each investors position (Quantity×Price) after the close of business each day into a preferred combination of shares in the two separate ETFs. The preferred combination, which is calculated for the investor after the close of business (by either the Fund Sponsor, Custodian, Clearing Agent or other designated party), provides investors with a new position of two new securities the next day. These two new securities, to be listed on or off the exchange floor, have a combined weighted average leverage of a determined amount (as per the prospectus) and are fixed for as long as Investors hold the two securities. Investors can then sell their two new securities either on the exchange intra-day in real-time to another investor, a market maker or directly back to the Sponsor (either intra-day, end of day or other defined period of time). Investors can have the option of liquidating either a portion of their position or their entire position using algorithms, their broker, or via electronic trading. Alternatively, investors can decide to increase their exposure to one or more of the securities in their accounts. After trading begins, linked derivative securities can then be listed and traded either separately or in combination with one or more of the ETFs on the Exchange or through alternative electronic communication networks, dark pools, the OTC or third market. The derivatives can act as a hedge security to be bought and sold against the ETFs.

In an embodiment, a solution is provided that is defined as a non-path dependent product offering a fixed leverage (Delta) over any period of time, regardless of when purchased or the path taken by the price of the security. It should further be available in a single ticker exchange traded product.

In an embodiment, a solution is constructed wherein the first step is fitting the model. In particular, we know that for a given total return index designed with two times leverage, the delta ratio of how the leveraged index will change in response to a proportional change in underlying price can be represented by the following formula:

Formula=2I(tu)/(2I (tu)−(Initial Leverage−1)*It)

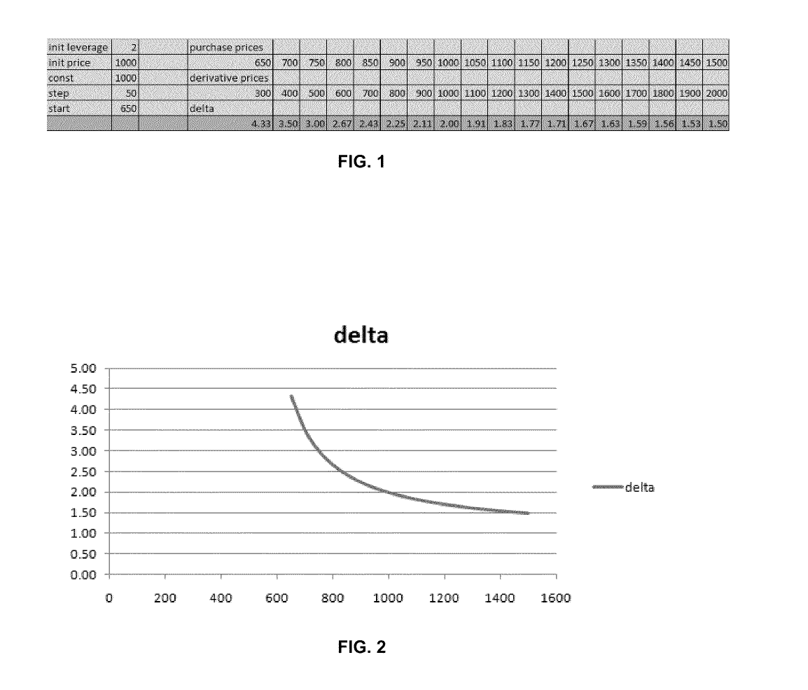

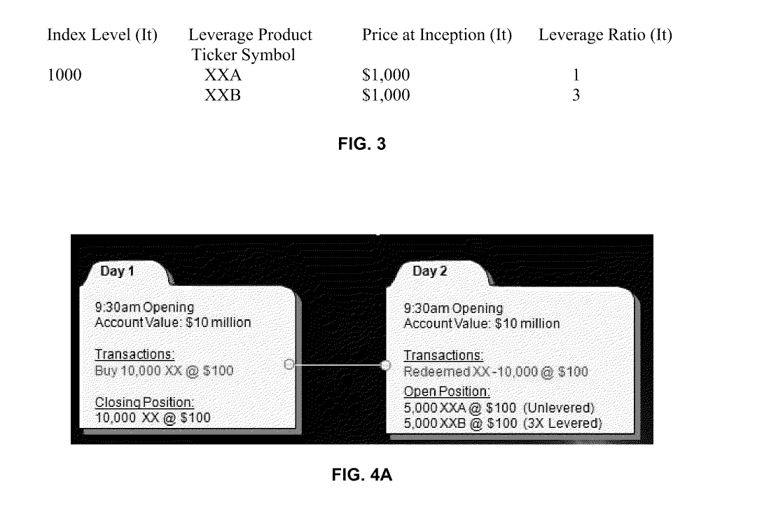

For example, if the SP500 is assumed to be 1000 and a corresponding 2× leverage Index also starts at a value of 1000, it will have a delta ratio of 2. If the SP500 increases 50% to 1500, the leverage index will then be 2000 and have a new delta ratio of 1.5, as shown in the table in FIG. 1 and corresponding chart in FIG. 2. Changing index levels will therefore correspond to changing delta ratios as the Index moves.

The second step in construction of the solution is creating multiple ETFs with various levels of delta ratios. In particular, by creating a strategic combination of two or more leveraged products and fitting them to a starting value linked to a benchmark or Index such as the SP500, one or more ETFs in singular, tandem or combination will provide a fixed weighted average 2× delta leverage and will be always be available at or near a given underlying index or benchmark level.

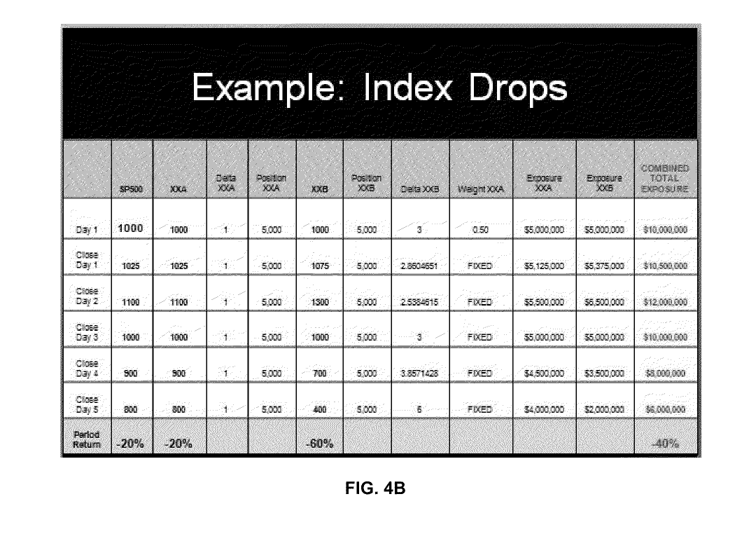

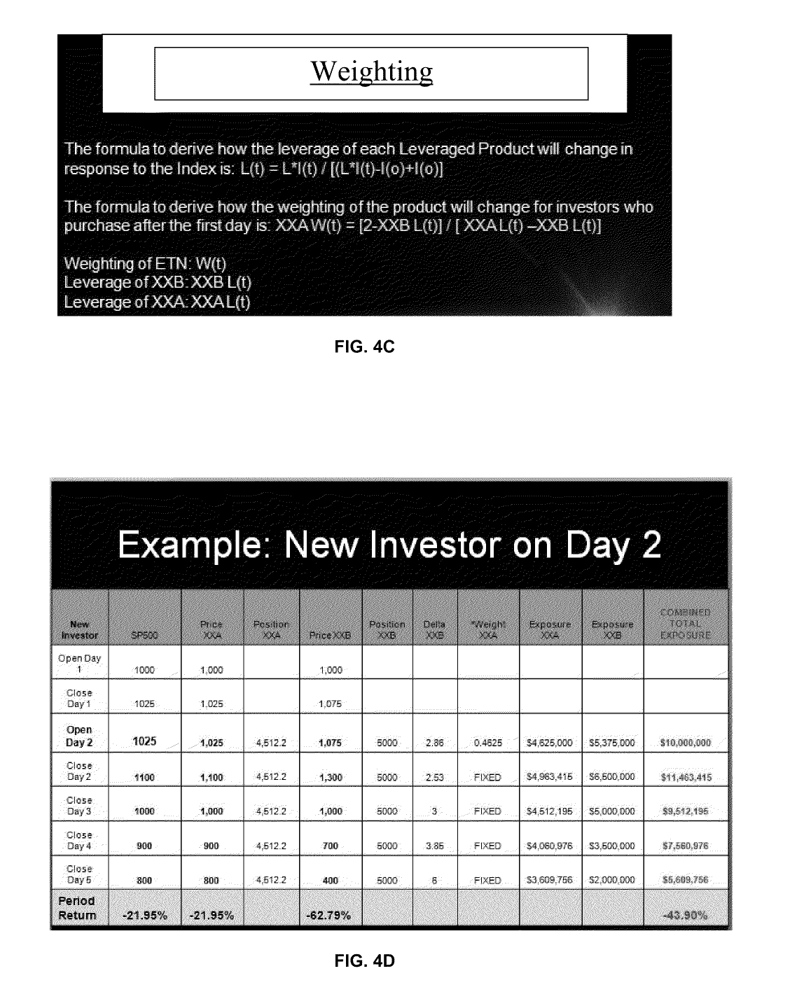

For example, if the S&P 500 is the underlying Index, and relying on the table of FIG. 4, then the formula to derive how the leverage of each Leveraged Product will change in response to the Index is:

L(t)=L*I(t)/[(L*I(t)−I(o)+I(o)]

The formula to derive how the weighting of the product changes for investors who purchase after the first day is:

XXA W(t)=[2−XXB L(t)]/[XXA L(t)−XXB L(t)]

Weighting of ETF: W(t)

Leverage of XXB: XXB L(t)

Leverage of XXA: XXA L(t)

The third step in construction of the solution is creating ETFs linked to the performance of the above indices. The below model describes the mathematical relationship between an ETF linked to the performance of a leveraged Index. There is no rebalancing or compounding of leverage.

Initial Price of ETF: Pt=It

Daily Calculation: Pt+1=Pt+[It+1−It−1*R*L]

Final Price of ETF: PM=It−IM−financing costs

wherein

Pt=Price of ETF at inception

It=Price of Index at inception

PM=Price of ETF at maturity

IM=Price of ETF at maturity

R=Initial Index Price at To/Po (Constant)

L=Leverage Factor (Constant Value)

Using the above model, multiple ETFs can be listed and traded. For every expected 33% negative movement in the underlying Index (for example), a pre-defined group of “at the money” or near the money ETFs are created and listed (as the 3× product will hit a stop loss to prevent investors from losing more than their initial investment in that product).

The fourth step in construction of the solution is creating one single product that maintains a fixed delta at all times. In particular, one final product is created to provide on a daily basis a fixed delta of 2. This product, structured as an ETF (referred to for reference as ticker symbol XX), will have at the beginning of each day a target leverage factor matching the target delta (2). At the close of each day, it will provide to its shareholders a performance return equal to the target delta for each discrete one day time interval. A unique and novel feature of this ETF (XX) is that at the end of each day, XX will automatically exchange to its shareholders its entire closing market capitalization for the equivalent dollar amount in securities XXA and XXB “in kind” (less fees and expenses). As this mandatory redemption feature will be an “in kind” transfer, it may be more tax efficient. Assets under management within XX at the end of the day will drop to a minimum maintenance level. Assets within the ETFs XXA and XXB, however, will combined contain the market capitalization of XX that existed at close of business in XX. At the close of business, an Authorized Participant (AP) or Sponsor will commit to buying a minimum amount of XX and new shares will be created for trading the next morning. The closing market price of XX in one embodiment would be used as the benchmark for the opening price for the next business day. The process would repeat itself everyday thereafter.

It should be noted that, prior to maturity date, a large threshold price movement may cause one or more of the leveraged ETFs to have a delta that falls below the target delta. When that happens, a new combination of ETFs may be required for XX to redeem into. For example, if XXB starts out with a delta of 3 and the index increases by a large percentage, XXB will have a delta of less than 2.0. As XXB in combination with XXA requires a combined delta of 2.0, two new ETFs will need to be created that XX will in one or more embodiments convert, exchange, exercise, redeem, expire or otherwise transform into.

The approach described in the paragraphs above overcomes the path dependency issues relating to current leverage products and provides a unique solution to provide a fixed leveraged product at any given moment for any required period of time at a relatively low cost. The solution benefits both long term buy and hold investors who could achieve long term capital gains tax treatment by holding the product for more than a year as well as short term traders, option hedgers, contract for difference (“CFD”) providers and end users.

Other advantages of the present invention may include:

A) Providing investors with a ‘same as margin performance’ with a potentially lower cost than buying on margin. The cost to operate the ETFs would be extremely cost competitive to investors who would otherwise have to pay the broker call rate (which is currently over 4%)

B) The ETF XX can be used as a wrapper to buy intra-day a portfolio of securities that are not listed on an exchange and transform at the end of the day into two securities (other variations are possible including more or less than two) who performance is linked to those securities. For example, there are thousands of managed mutual funds with over $11.5 trillions of dollars of assets that are not listed on an exchange. Under one embodiment, the leveraged (or in an alternative embodiment non leveraged) ETF would transform into two products that provide a leverage return profile linked to the value of the OTC product at the end of the day, week or month or other user defined period of time (such as hourly, intra-day or in real-time).

C) Allowing an investor to buy an exchange traded product providing non path price dependent leverage on restricted securities, illiquid securities, hybrid securities, non-deliverable forwards, single stocks, ADRs and other investable and non-investable asset classes including but not limited to commodities, agricultural products and metals, currencies and other securities as discussed in Appendix A, below.

D) Daily Leveraged and Inverse ETPs with no tracking errors caused by price path dependency, compounding or leverage drift.

E) The performance received is the performance expected in both rising, falling and trending markets.

F) Investors can use the product as a fixed delta hedge.

G) Options traders can more effectively hedge their delta, gamma, theta, rho and other greek exposure risk to an underlying index.

H) Fund managers and sponsors are not subject to front running (which current daily leveraged ETP providers are exposed to as they need to rebalance their portfolios at the end of each day).

I) Investors can buy options on the ETP (XX) which would deliver into one or more fixed, non path dependent products (XXA, XXB individually or in combination).

J) A class of shares can be listed on the leveraged products.

K) The portfolio can be displayed either partially, in full, or not at all, on a delayed or real-time basis.

L) Investors are not forced to buy and sell their fund shares on a daily basis to maintain fixed leverage, allowing them to receive long term capital gains treatment (if their investments go up).

M) Each of the one or more leveraged products in the preferred embodiment can have a stop loss feature to ensure that investors do not lose more than their initial investment.

N) Investors will have a single security product that they can trade in and out of during the day. If they hold the product overnight, their position in the ETF will be automatically redeemed and the new securities (for example XXA and XXB) will appear in their brokerage account. Investors can keep their new ETP positions (XXA & XXB) or sell them at any time on the open market the next business day or directly to the Sponsor.

O) No path dependency can equate to Longer Holding Periods which can equate to more revenue for Fund Sponsors. Because of the superior tracking of the underlying Indices overtime, investors may consider changing their investor behavior and hold the proposed products for long periods of time, generating more revenue for the sponsors.

P) Investors can receive a ‘set and forget’ constant leverage exposure to a benchmark or index, providing a more compelling user experience than having to actively manage their position at the end of each day.

Q) By listing a leveraged ETP on a single stock like IBM, investors can achieve a unique method of gaining leverage over traditional options on stocks. One of the unique attributes of the preferred embodiment (XX) includes avoiding the theta risk and time decay inherent in the option pricing models of options on stocks. For example, instead of having to be right on both the direction AND the timing of when the security moves, an investor in XX needs only to be correct as to the price movement of the underlying index or benchmark (taking into consideration the built in stop loss feature). Note that options on an ETP linked to a performance of IBM, however, would be subject to theta and time decay.

R) By listing a leveraged ETP on a single stock like IBM, investors can achieve a unique method of gaining leverage over single stock futures. With single stock futures, an investor opens a margin account and (currently) pays higher capital gains taxes on profits if held for more than one year. In addition, futures investors ‘roll’ their positions over at contract maturity, contributing to increased brokerage and trading costs. With a leveraged ETP on a single stock, no margin account would be required, there would be lower capital gains on profits if held for more than one year and no requirement to roll positions.

S) Various strategies can be employed with the present invention, including tax loss harvesting (sell a highly correlated security to the ETP and lock in the loss, then buy the ETP), convertible arbitrage, dividend arbitrage, high frequency trading, relative value (short a price path dependent leveraged ETP and buy the proposed non-price path dependent leveraged ETP, long/short, fundamental pairs trading, etc.

Further advantages may include the ability to trade a futures contract on a both a fund share (XX or other ETP structure), an index of fund shares (or other ETP structure) with linked derivative securities, or funds of funds (where the leveraged ETF invests in other leveraged or non leveraged ETFs). An index would allow greater diversification, lower transaction costs, expanded investment choices and the ability to measure their fund performance against a relevant benchmark. The index can be calculated many different ways with a great deal of flexibility; equal price weighted, capitalization weighted, geometrically weighted, market value weighted, market share weighted, attribute weighted, custom weighted, revenue weighted, factor weighted or user defined weighted, depending upon the need.

Turning to the figures, FIG. 4A represents how the preferred embodiment of an ETF with a mandatory daily redemption feature that, when held through the close of business, automatically redeems into two separate ETFs that are already listed on the Exchange and trading; the first ETF being un-leveraged and providing a 1×(i.e., one times) return to an index, the second being a leveraged ETF and providing 3× (i.e., three times) the total return to the index; the two funds above in combination providing a weighted average leverage of 2 (for example) that is fixed for as long as the investor holds the two ETF positions.

In order to give an investor a target leverage of 2× (i.e., two times the total return of the index), the proportion of how much money should be invested in securities XXA and XXB on a daily basis is discussed in greater detail. On the first day that securities XXA and XXB are created, it is mathematically determined that 50% of the money invested by Investor A should be split equally between security XXA which has a leverage factor of 1 and security XXB which has a leverage factor of 3. Combined, they provide a weighted average leverage of 2.0. But as will be shown, the leverage factor of security XXB will change for a new investor (Investor B) who purchases on the second day. Therefore, the proportion of money for Investor B is different than it was for Investor A. For example, on Day 2, the index has moved up 2.5% to 1025. Security XXB, which had a leverage factor of 3 on Day 1 now has a leverage factor of 2.860465116. The calculation of the new leverage factor is performed using the below formula:

L(t)=L*I(t)/[(L*(I(t)−I(o))+I(o))]

To result in an exemplary calculation of:

2.860465116=(3*1025)/(3*(1025−1000)+1000)

As the leverage decreases from 3.0 to 2.86 as the index has increased, a new investor (Investor B) must now purchase more of security XXB in comparison to security XXA to receive a weighted average leverage of 2.0. A new investor must now allocate 53.75% of capital to security XXB and 46.25% to security XXA. The weighting on any given day for security XXA is calculated using the following formula:

(Target Leverage−Current leverage XXB)/(Current Leverage XXA−Current Leverage XXB)

In this example, the 0.4625 is calculated as follows:

(2−2.860465116)/(1−2.860465116)

which can be displayed in percentage form (46.25%)

The weighting on any given day for security XXB is:

1−XXA weighting

To result in an exemplary calculation of:

0.5375=1−0.4625

In an embodiment, if either Investor A or Investor B had owned security XX (the security which is exchanged daily into security XXA and security XXB), then security XX would have allocated the shares in the correct proportion for the investor automatically. Alternatively, the investor can make the calculation himself and invest directly into security XXA and security XXB using the above formulas. Moreover, the leverage and weighting formulas can be calculated and disseminated by either the exchange, the issuer or sponsor, or a related third party market data provider (like BLOOMBERG or REUTERS) or any combination thereof in real-time, intraday, end of day, or at user defined intervals to provide investors with the ability to achieve fixed, point-to-point leverage with little or no tracking error. For instance, the bid/ask spread, commissions or the expense ratio of the products may cause a deviation from the index or benchmark return, but that is not deemed to be due to the structure of the product itself.

The calculation and dissemination of the leverage and weighting formulas can involve retrieving and storing market price data for a portfolio of securities, calculating using mathematical variables formulas representing target leverage data values, index values, threshold leverage levels, processing said information, sequentially storing, and exporting to a query-able file, data feed, or database (or algorithm that derives the ratio) resulting in final values over a client server network, internet, intra-net or co-location facility using computer processors, flash and/or stored memory and other computer apparatuses for parsing data and text information, calculating information, storing information and disseminating information in humanly readable format.

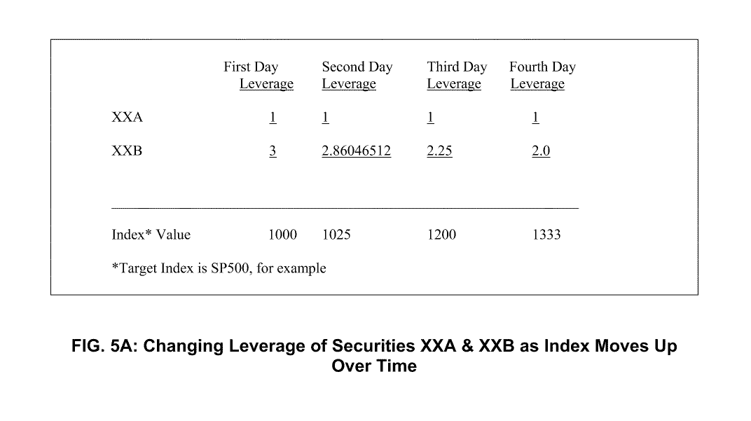

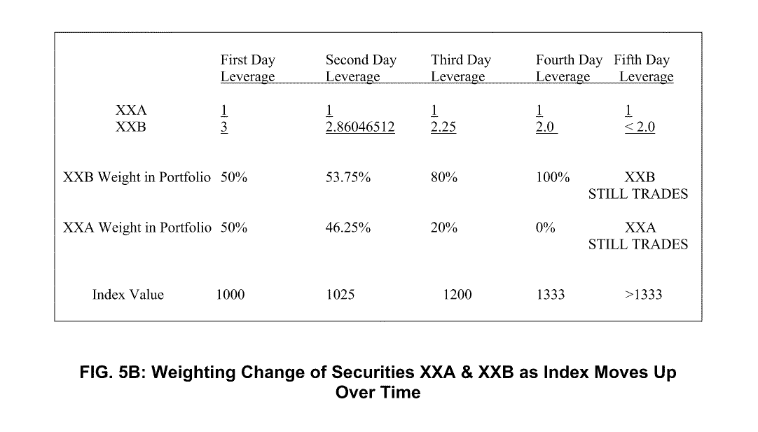

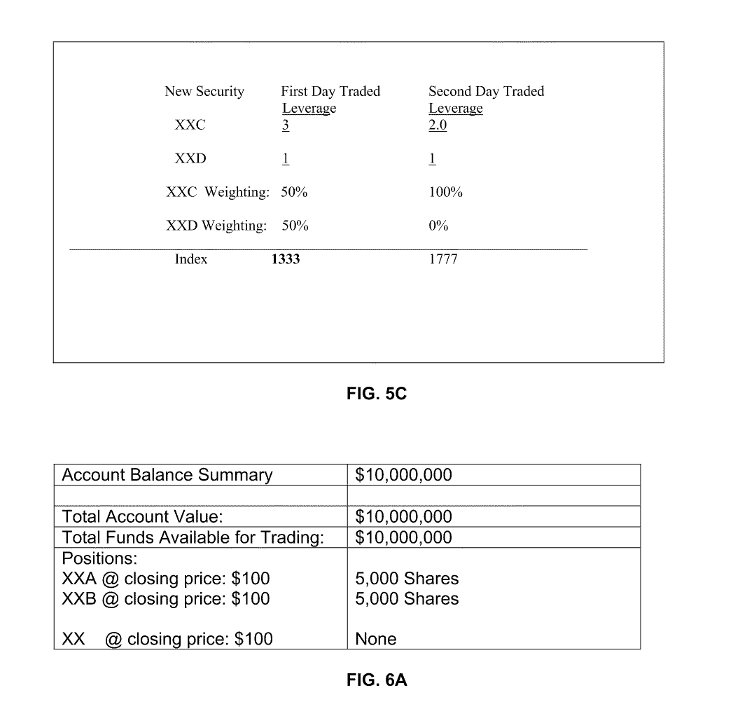

FIG. 5A illustrates, in an embodiment, that as the index rises, the market price derived leverage of security XXB declines. The market price of security XXB will rise in this example at three (3) times the rate of the index. Security XXA will rise at one (1) times the rate of the index.

FIG. 5B illustrates, in an embodiment, how the weighting changes for securities XXA and XXB as the Index moves up over time. Investors will receive different portfolio weightings of the two securities depending upon the index value of the day they purchase security XX and the resulting leverage of securities XXA, XXB.

FIG. 5C represents in an embodiment, how an Index has moved above a threshold level where at least one of the initial securities (XXB) in FIG. 5B has a market price derived leverage below the target leverage level (in this example 2), two new securities (XXC & XXD) are created. When the Index goes above 1333, a new set of products are created that security XX can be exchanged into (securities XXC and XXD) because, desirably, within the embodiment at least one of the securities has a price derived leverage of at least the target leverage rate (2.0) at all times. FIG. 5C shows creation of new securities when the Index goes above 1333. Also, the exchange of security XX into securities XXB and XXA can be structured at the beginning, during or at the end of day, or deferred until a user defined period of time (e.g., more or less than one day, week, month, year, multi-year time or combination thereof).

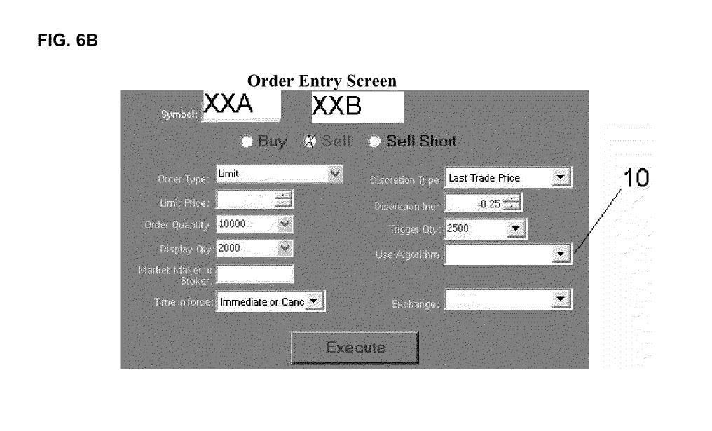

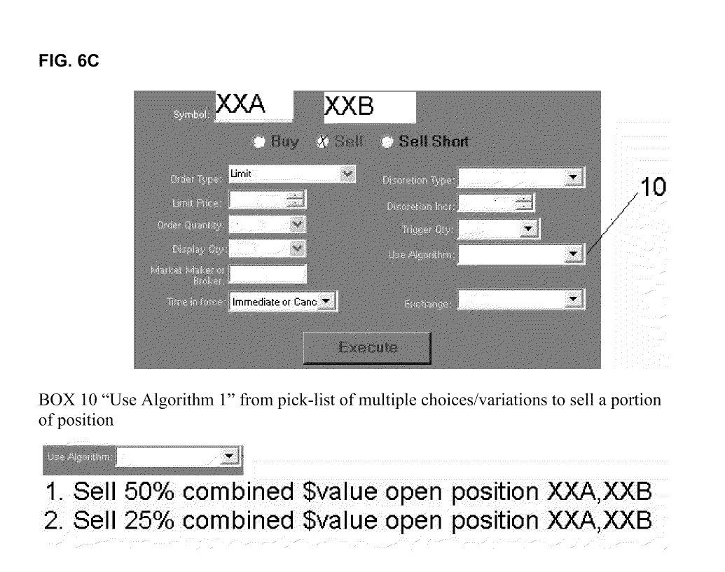

FIGS. 6A, 6B and 6C illustrate an embodiment of an electronic order entering, execution and trade processing tool that allows in “one click” or more the ability to close out the securities received by an investor who holds security XX for more than one day. FIG. 6A illustrates online brokerage account information for the owner of securities XXA and XXB. In addition, FIG. 6B illustrates an online brokerage order entry screen to facilitate a full liquidation of an investor position in XXA, XXB. Further, FIG. 6C illustrates an online brokerage order entry screen to facilitate a partial liquidation of an investor position in XXA, XXB.

Turning to FIG. 6B, a window or box 10 is provided wherein: 1. Leave Use Algorithm Blank; 2. Computer retrieves from broker open position of XXA, XXB in FIG. 6A; 3. Computer retrieves Weighting Ratio of leverage products as discussed in FIGS. 4A-4D detailed description of drawings; and, 4. Sell % of position applying weighting ratio by taking order quantity in FIG. 6B of XXA and XXB (10,000 combined) in relationship to FIG. 6A (10,000 combined) by clicking Execute. An authentication process occurs against the open position to confirm that the total amount being sold is held in the investor account. Moreover, in a different embodiment, the labeling for order quantity can be changed to “Combined Order Quantity” or “Combined Total Position”. Alternatively, instead of a sell, the order type can be a Buy transaction to open a new position in XXA, XXB using the current weighting ratio.

Turning to FIG. 6C, choice # 1 of the sample algorithm methodology is to execute a sell of 50% of combined position of XXA, XXB from open position: 1. Retrieve from broker computer database for the shareholder the open position of XXA, XXB in FIG. 6A; 2. Retrieve Weighting Ratio of leverage products as discussed in FIG. 4A-4D detailed description of drawings by querying a file, data feed, database (or algorithm that derives the ratio) from publicly available market data available over a client server network, internet, intra-net or co-location facility using computer processors, flash and/or stored memory and other computer apparatus for parsing data and text information, calculating information, storing information and disseminating information in humanly readable format; 3. Provide computer software functionality that allows a user to sell a percentage (%) of his/her overall position by applying a weighting ratio. In this example, the ratio would be calculated by taking the appropriate combined quantity of XXA and XXB (in this example 5,000 combined) in relationship to FIG. 6A (10,000 combined); 4. Clicking execute sends order to exchange or OTC market for execution over a computer network. Upon execution, it would be sent to an exchange clearing computer and/or DTCC/NSCC for clearing and settlement. Alternatively, the order type could be switched from “Sell” to “Buy” which allows an investor to open and establish a new position, or add to an existing position, utilizing the same concepts discussed in steps 1 through 4 above. An additional algorithm can be provided for an investor to purchase a predefined or manually entered dollar amount of XXA, XXB (the two products in combination) to provide a non-price path dependent leveraged return satisfying a specific leverage level.

The apparatus tool of FIGS. 6A, 6B and 6C can be used in conjunction with a brokerage account that holds the existing position of securities XXA and XXB. For example, as indicated above, if the investor wanted to liquidate 100% of his position (FIG. 6A), he could click a word, symbol, button or icon labeled to describe a Sell transaction (FIG. 6B) and positions in both securities (XXA, XXB) would be sent to the exchange for execution (or sponsor/issuer). Alternatively, if the investor only wanted to sell a portion of his open position, he could click “Use Algorithm” located in Box 10 (FIG. 6C) to sell either a fixed predefined dollar $ value (or a percentage value from 0-100 to be supplied in a further data value input field). These choices are processed in accordance with either the closing or current intra-day ratio required to maintain a residual position that maintained a fixed non-price path dependent leverage. The ratio can be provided to the investor in a method that allows the investor to execute the order without having to calculate manually the amount required to sell a partial position and still maintain a fixed, non-price path dependent return for the remaining position. The ratio can be related to the one described in FIGS. 4A-4D. The resulting processed order can include the calculated number of shares required to sell and/or the related price of each security and is automatically sent to the floor of the exchange wherein it should be understood that commissions and bid/offer spreads would impact the investor capital account. The tool can also be used to open a new position or add to an existing position either intra-day or non-intra-day using a “Buy” or a “Sell Short” order wherein it should be understood that there are variations such as limit and/or spread orders.

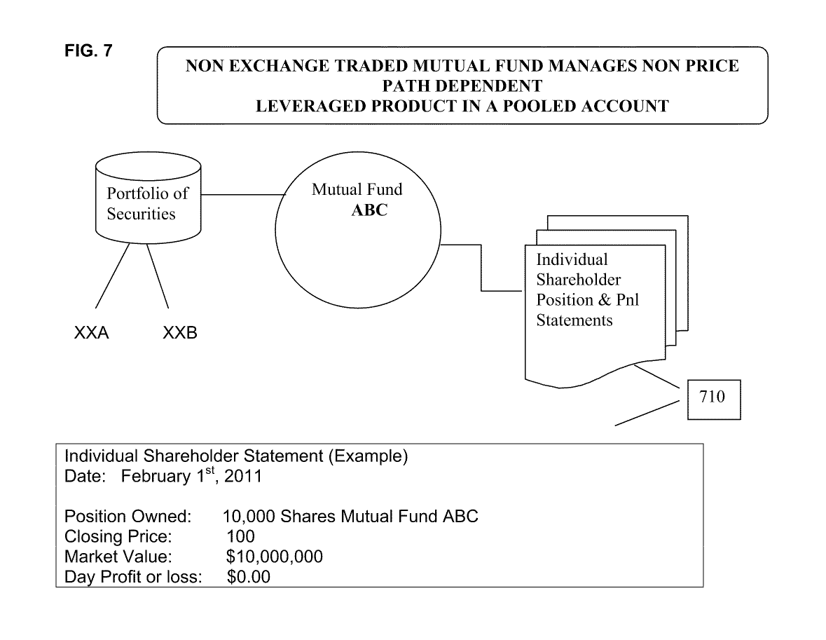

FIG. 7 illustrates how a non-exchange traded mutual fund generates shareholder position reports in either a pooled or managed account system. In window or box 710 of FIG. 7 the Fund displays position only in terms of shares Mutual ABC (i.e. XX). Each individual shareholder will have a unique statement. The information displayed in the statement may be adjusted to disclose more or less information than the example above. It should be understood that a general ledger computer software program will be used by the Mutual Fund to generate balance sheet and income statement data in conjunction with portfolio management, fund accounting, asset management, shareholder record keeping and other accounting software to update and maintain any financial reporting requirement including (net asset value calculations) for the shareholders not only in this figure but for any product created by any sponsor or issuer throughout this specification where needed. Shareholders could enter an order to sell Mutual Fund ABC (a single ticker product) instead of XXA, XXB either by requesting a dollar amount or share amount to sell. The amount of shares owned and displayed in the investor account of Mutual Fund ABC could increase, decrease or remain the same depending upon either market price movements of XXA, XXB or capital withdrawals or increases. Note that a variation would be to display the underlying portfolio holdings of XXA, XXB. Alternatively, a managed account could be created whereby a Registered Investment Advisor would maintain the account on behalf of an investor and make the requisite purchase or sales directly with the Mutual Fund. In any embodiment, the Mutual Fund Company could create either exchange traded or non exchange traded versions of XXA & XXB.

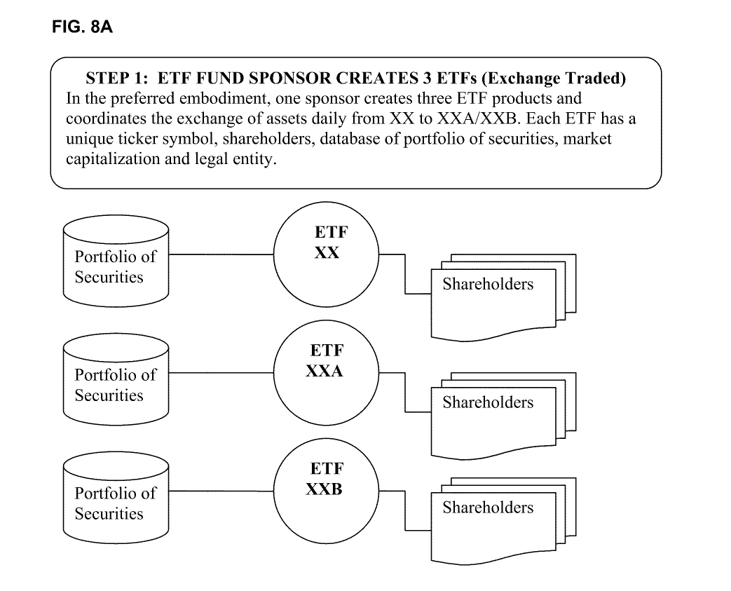

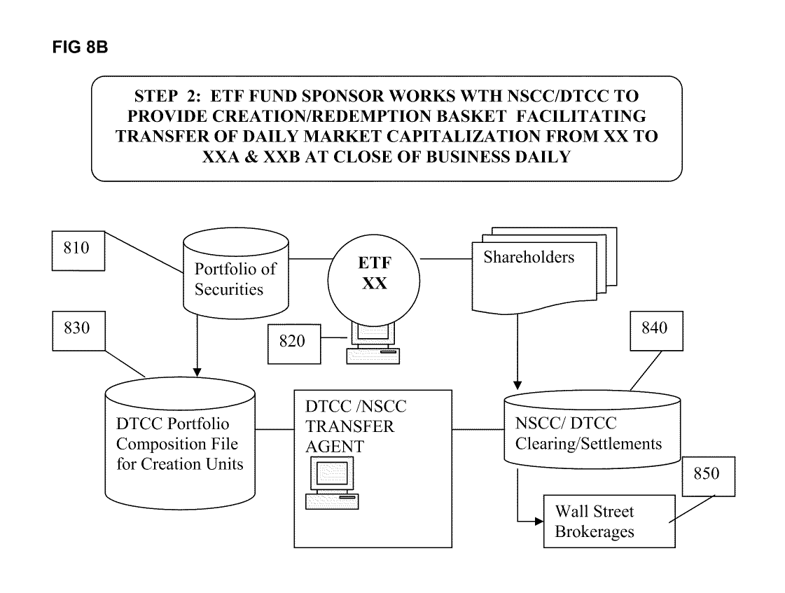

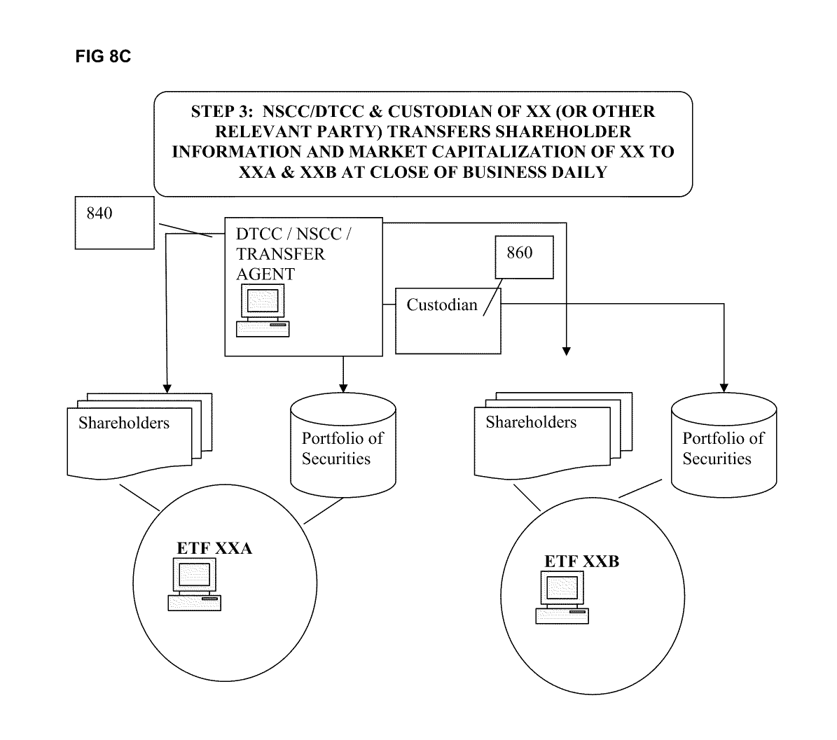

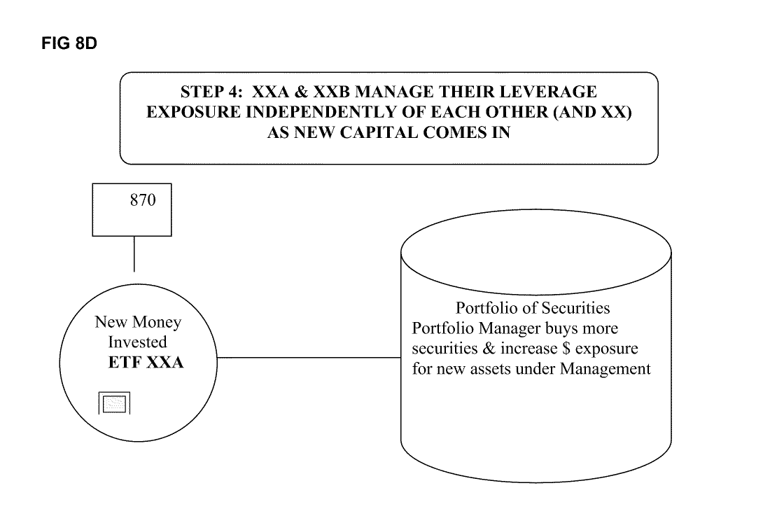

FIGS. 8A-8C depict a creation/redemption process occurring for one or more of securities XX, XXA, XXB in real-time or intra-day by using the following steps:

1. A person who owns either a unit or share of the underlying ETN or ETF or related structure provides the group responsible for creations and redemptions, including but not limited to authorized participants, the custodian, exchange, clearing corporation, department, market marker, issuer and/or brokerage firm, with an electronic notification that they wish to create or redeem shares intra-day. The notification can have several different execution choices, including creating or redeeming at a specific price related to the underlying security that is held by the ETN or ETF(or other ETP), bid/ask, spread, or algorithmic mathematical relationship, for a defined time period (including sub-second, seconds, minutes, hours, daily, weekly, monthly, yearly or user defined period).

2. In the case that a creation order had been placed, an electronic transfer occurs into or out of the account of the entity or person who placed the order for securities that represent the dollar amount requested to be created.

3. In the case that a redemption order has been placed, an electronic transfer occurs into or out of the account of the entity or person who placed the order for securities that represent the dollar amount or value requested to be redeemed.

4. All of the above steps can use computers to store information relating to the ownership of shares, computer code instructions to add and subtract shares from relevant brokerage and clearing accounts, including but not limited to DTCC, NSCC, Custodian, an Exchange. One of the benefits of allowing intra-day creation/redemptions is that arbitrageurs can lock in profits immediately and reduce their balance sheet usage during the day. This allows them to make more money as they can trade more products during the day.

Turning specifically to FIG. 8B, at reference number 810 a Fund Sponsor calculates using a portfolio management computer system the closing market capitalization of fund by valuing a portfolio of securities held. At reference number 820 the Fund Sponsor calculates the leverage and weighting proportion required to provide shareholders at the close of each business day with an ongoing fixed, constant leverage consistent with the closing market price of XXA and XXB. At reference number 830 the Fund Sponsor XX provides DTCC with a portfolio composition file and/or shareholder information that will be redeemed into XXA, XXB. This information is also displayed directly and through market data vendors to authorized participants. At reference number 840 the DTCC clears and settles trades, and updates shareholder information in conjunction with Transfer Agent. At reference number 850 each individual shareholder position is updated and processed electronically, then sent to Brokerage firms.

Turning specifically to FIG. 8C, at reference number 840 Fund Sponsor XXA and XXB are informed by DTCC/NSCC/TRANSFER AGENT and/or Fund Sponsor XX of the new shareholders. Further, at reference number 860 Custodian of XX transfers securities (and market capitalization) to XXA, XXB (or their custodian).

Turning specifically to FIG. 8D, at reference number 870 Fund Sponsor XXA receives more capital. XXA Maintains leverage of 1 to SP500, but increases the dollar ($) amount of exposure by the amount of new capital that comes in. XXB (not shown) would increase the amount of $ exposure by the amount of new capital that comes at the closing price derived leverage level of its 3× total return swap as discussed in detailed description of drawings FIGS. 4A-4D. XX (not shown) would increase the amount of $ amount exposure by the amount of new capital that comes at the closing price to maintain a fixed (in one embodiment) 2× exposure to an underlying index or benchmark. Moreover, if redemptions occur from XXA or XXB, then the amount of exposure would decrease. Also, with regard to the steps shown in FIGS. 8A-D, the steps can occur in any order and can be repeated at user defined time periods either separately or in combination.

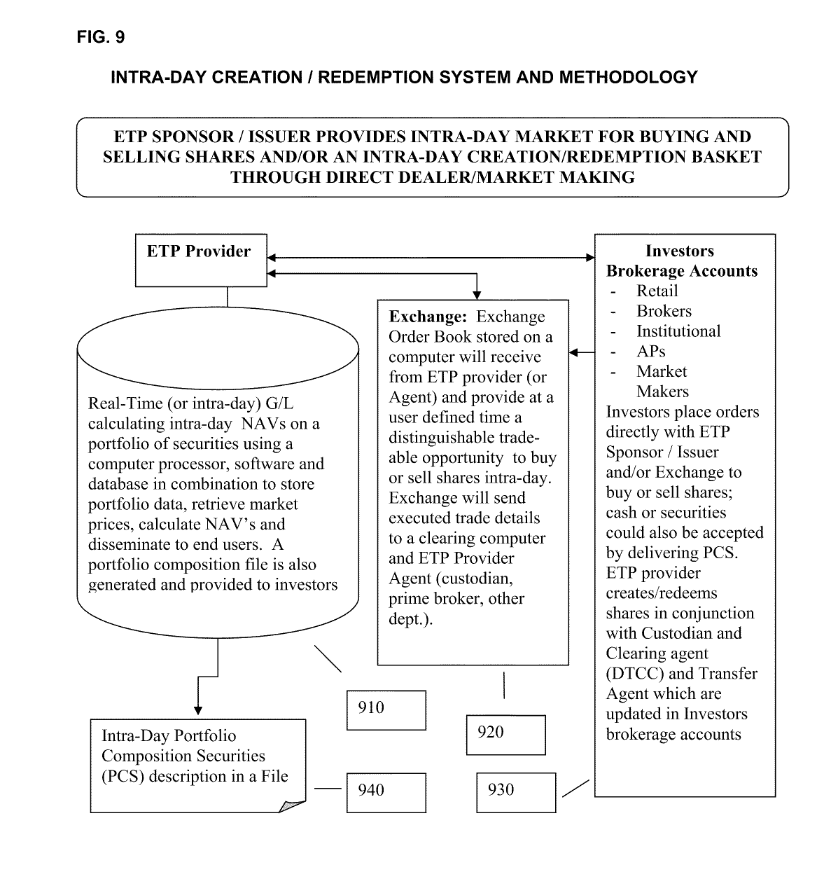

FIG. 9 illustrates how an intra-Day Creation/Redemption process is made possible by an Exchange Traded Product Sponsors/Issuers through Direct Dealer/Market Making. In FIG. 9 one step for making an intra-day creation/redemption process work is by having a robust (in one embodiment real-time) general ledger capable of striking multiple intra-day NAVs as shown in Box 910. Once the NAV has been calculated, a trade-able opportunity in the form or either a price (or non trade-able indicative price range might be posted in the order book on the floor of the exchange) as shown in Box 920. Otherwise, no price would be displayed and investors would not receive the price until after their order was placed and settled. If no price is displayed, an alternative placeholder such as “NAV” might be displayed. Alternatively, the Investor can review the portfolio composition file as shown in Box 940 and submit the creation/redemption request directly to the ETP provider as shown in Box 930.

One of the disadvantages of the current end of day creation/redemption process is that intra-day market makers may back away from making markets in ETFs (for example) during large volatility swings, as evidenced by the ‘flash crash’ of 2010. To mitigate the liquidity risk taken by investors during the day, ETF fund sponsors can generate real-time market liquidity by acting as direct dealers during the day. By striking intra-day NAVs in real-time, on an hourly basis or other user defined period intraday, ETP sponsors can reduce the premium or discounts during the trading day as well as the trading friction costs incurred by investors imposed by bid/ask spreads on the exchange floor. The key to making an intra-day creation/redemption process work is by having a robust real-time general ledger capable of striking multiple intra-day NAVs as shown in box 910. Once the NAV has been striked, or in the case of an ETN, an alternative price indication of what the issuer would accept to redeem or create, a trade-able price can be posted in the order book on the floor of the exchange as shown in box 920. Alternatively, the Investor can submit the creation/redemption request directly to the ETP provider as shown in box 930. The preferred embodiment is an ETP Sponsor/Issuer that can provide securities in lieu of cash in the creation/redemption process to maintain tax efficiency. Other variations are possible, such as ETPs that provide cash in lieu of securities, but they may not be as tax efficient (which might necessitate the need to create a separate class of shares). The creation/redemption process can be followed by a notification of the change in shareholder positions to a clearing/settlement entity, either by the ETP provider or the exchange, as well as settlement of securities and/or cash to/from the Investor brokerage account. Two embodiments for the framework that illustrate an automated method of enhancing intra-day liquidity are graphically illustrated. It should be noted that the preferred embodiment is where the Investor executes a trade on an exchange by buying or selling at a trade-able price, the price distinguishable by other prices identified being offered. The distinguishing characteristic of the price would be an association of a corresponding code, such as a Broker Code, that represents the ETP provider or agent thereof.

While the above description contains many specific examples, these should not be construed as limitations on the scope of the invention, but rather as an exemplification of one or more preferred embodiments thereof. Many variations are possible. For example, various combinations of different securities could also be used. As an example, instead of using an ETF structure, an ETN, Grantor Trust or a user defined security including but not limited to those found below in Appendix A, either individually or in combination could be incorporated into the proposed products. For example, an ETF could redeem into an ETN; an ETN could redeem into an ETF. As will be appreciated by those having ordinary skill in the art, other embodiments of the current invention are possible including, but not limited to, creating an ETP that invests in other ETPs or has a separate share class. Other variations of the security XX construct (i.e., a security which transforms daily into a multi-product security) includes the ability of the security XX sponsor/issuer to accept from authorized participants a ‘creation or redemption’ basket containing a preferred combination of securities XXA and XXB or other defined acceptable securities. In the event of a market disruption event, the reference assets XXA and XXB could be replaced with securities offering similar or substantially the same economic value. In addition, the unique aspect of the mandatory daily redemption feature by itself allows the scope of this aspect invention to be applied to an unleveraged product. For example, security XX could begin its day as an unleveraged product, with a BETA of 1 for example, and deliver a basket at the end of the day that contains a portfolio of securities containing a leverage factor greater or less than the starting leverage factor.

In addition, put and call options, either American, European, Bermuda Style, Quanto or otherwise exotic, could be listed on security XX or on the delivery basket of security XX—a combination of both securities XXA and XXB. These options can be listed and traded either on or off the exchange floor (with or without an automatic exercise feature). Options exercise-able into a position of securities XXA and XXB could be based upon a published ratio derived in accordance with FIGS. 4A through 4D or other user defined value. These derivative options, with an expiration date or expiration-less, could be at the money or deep in the money long term options, expiring more than a year in the future, which would allow an investor to purchase a single ticker product to be opened and closed without having to take delivery of securities XXA and XXB, either in combination or individually, providing a future, in one embodiment, leverage return.

In lieu of an option, a warrant product (with an expiration date or expiration-less) can be listed that would exercise into securities XXA and XXB either at maturity or prior to maturity in accordance with a mandatory redemption feature. In addition, single day options can be listed on security XX which would exercise into securities XXA and XXB. Other alternative single ticker products that can be created include an ETP that invests in options that are exercisable into securities XXA and XXB or invests in securities XXA and XXB directly. In addition, a single ticker exchange traded or non-exchange traded mutual fund version of security XX can be created that keeps a general ledger accounting of the pooled interests of its portfolio (instead of creating and distributing shares of securities XXA and XXB into the accounts of investors to buy or sell individually (in a transparent, visible manner), it keeps track of their fractionalized interests for them in an accounting system. When investors wish to sell their mutual fund, they can contact the mutual fund directly. Investors do not see securities XXA and XXB in their account, only a single ticker mutual fund (as shown in FIG. 7, for example). Mutual Funds may or may not decide to display the component securities in their client accounts when they report to their clients their monthly, quarterly and/or yearly position and pnl statements.

Alternatively, the fractionalized interest associated with securities XXA and XXB in an accounting system can be reported to shareholders as units of security XX (which could change over time). The portfolio management style of the mutual fund could be active, passive, semi-active or semi-passive. The portfolio objective can be diversified or non-diversified. Some or all of the proposed ETPs can be created and utilized in a defined contribution plan (401k) or other retirement or tax sheltered account.

Accordingly, it should be emphasized that the above-described embodiments of the present invention, particularly, and “preferred” embodiments, are possible examples of implementations merely set forth for a clear understanding of the principles of the invention. Many variations and modifications may be made to the above-described embodiment(s) of the invention without substantially departing from the spirit and principles of the invention. For example, instead of having a creation process occurring at the end of the day for security XX, it could occur in real-time or intra-day in accordance with the invention as described in FIG. 9A.

Alternative structures can be used besides an ETF, including a Trust (including a business trust, grantor trust, unit investment trust) and/or a fixed income product including an exchange traded note, security, bond, using a conversion or convertible or exchangeable or Paid in Kind (PIK) feature or a security listed below in Appendix A. Alternative portfolios can also be invested in such as those listed in Appendix A, including a combination of leveraged and or non-leveraged securities. The related steps for creating an Exchange Traded Product in accordance with the present invention may be inclusive of:

A. Filing a prospectus and/or registration statement with the S.E.C. (or comparable foreign government agency).

B. Registering the product under Investment Company Act of 1933, 1934, 1940 (or other domestic and/or foreign Act(s) and sections as required) as well as receiving exemptive relief from relevant sections.

C. Have an issuer or Sponsor create the product and receive a CUSIP, ISIN or other security identifier (from a clearing or settlement company, for example).

D. Listing the product on an exchange (or off the exchange, for example)

E. Allowing Investors to place orders to buy or sell the products at agreed upon prices either electronically or non electronically.

F. Market makers (or sponsors) buy and sell the product by posting bid and ask prices.

G. Market makers (or other investors) execute a hedge to their purchases and sell the product by buying or selling the underlying, a linked derivative security or correlated security, benchmark or otherwise acceptable hedge or arbitrage prescription.

H. Settling the product at the end of the day with a settlement price, estimated Net Asset Value (NAV), NAV or Indicative NAV.

I. Have the issuer or sponsor Create/Redeem product from authorized market participants (either market makers, retail or institutional investors) on a user defined time interval, including real-time, during the day, intra-day, close of day, weekly, monthly, yearly, multi-yearly for a defined amount of shares, units, contract, nominal or dollar value.

J. Display portfolio and its component values, broken down into one or more pieces in humanly readable form, fully or partially for some or all participants to see (in real-time, intraday, daily or delayed) including delivery basket, residual cash, intraday indicative value (IIV), hedging basket, creation basket, redemption basket, net asset value, interest, factor, financing, security or security holdings (whether displayed in full, partially or not at all), referenced assets, index or indices (whether estimated or actual) on an intraday, real-time basis, delayed and/or as well as closing day basis.

In addition, an index can be created based upon such requirements that the index be limited to just one benchmark or investable security, such as an equity (i.e. IBM), an ETF, an ETN, an ADR or a derivative. Another benchmark or index variation or ETP structure can be one that is based upon one or more asset and sub asset classes, including but not limited to leap options, each of which are exercise-able either individually or in combination into one or more securities (such as those securities found below in Appendix A) providing a fixed non-price path dependent leveraged return. To address any concerns about the leverage of security XXB reaching a high beta, a custodian, prime broker, brokerage firm, exchange, DTCC or a clearing/settlement entity can flag the CUSIP or ISIN or other security identifier of either XX, XXA and/or XXB (each separately or in combination) as being a security or group of securities that can only be sold, not bought in the open market (or conversely-bought, not sold). This can prevent speculators from just investing in security XXB.

In a different embodiment and application of a mandatory redemption feature, it could also be used to mitigate contango (when the futures price is above the expected future spot price), backwardation (the opposite of contango) or an inverted market (this is when the current (or short-term) contract prices are higher than the long-term contracts) for commodities and futures markets. For example, instead of having a portfolio that “rolls” forward an underlying position in a specific futures market on a month to month basis, the portfolio of the ETP could simply cash settle a portion of its portfolio (futures, contract for differences (CFD) or other trades) on a monthly (or other periodic or user defined) basis.

For example, given a spot price for a commodity such as oil and a related strip of futures (as shown below), various periodic (and mandatory) redemptions could occur.

Spot Oil: 90.00

Front Future Month (February 2011): 92.45

Second Front Future Month (March 2011): 93.29

Third Front Future Month (April 2011): 94.00

The portfolio could purchase the following transactions (using futures or CFDs):

1. Enter an order to buy spot at 90 and sell front month at 92.45.

2. Enter an order to buy the front month at 92.45 (or spot) and sell second month at 93.29

3. Enter an order to buy the second month (or spot) and sell the third month at 94.00

The portfolio could redeem (or alternatively distribute, deliver, dispense, issue, payout, transfer, exchange, transform, disburse, liquidate, divest, bifurcate, trifurcate, release, disgorge or otherwise allocate) either through cash, securities, or dividends (stock or cash) a portion of its portfolio each month (transaction 1 in 60 days, transaction 2 in 90 days, transaction 3 into 90 days) to its investors. The liquidation (or redemption) of each sequential trade would effectively be a mandatory periodic (as opposed to daily) redemption based upon a strategy trading methodology. Leverage could be applied to each of these transactions through borrowing capital or employing other types of derivatives (including but not limited to total return swaps). Alternatively, a variation of reinvesting capital could be provided to investors so that proceeds from unwinding transaction 1 could be applied to entering into a new 4th, 5th etc. transaction. This type of passive management could be increased in frequency to active management of the portfolio by one or more portfolio managers. A summary of the various embodiment combinations can be found below in Appendix B. In addition, the leverage amount may vary in XXA and XXB in various amounts as long as the total leverage is equal to the target leverage. Furthermore, the leverage weighting ratio can be adjusted to accommodate any change to make the resulting leverage a specified amount.

Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

APPENDIX A

The securities below are not meant to be an exhaustive list of asset classes, security types, security groups, sectors, subsectors or industries, but examples thereof. Many other types, variations or combinations are available. Each of the below securities can either comprise a holding, benchmark, index, reference asset, underlying or derivative of either security XX, XXA and/or XXB as described in FIGS. 4A-4E or any other Figure enclosed within this specification.

I. DEBT SECURITIES: 1. Government; 2. United States; 3. Sovereign; 4. Asset Back Securities; 5. Passthrough Securities; 6. REMIC (Real Estate Mortgage Investment Conduit); 7. Bonds: 7(A). Convertible, 7(B). Preferred, 7(C). Revenue, 7(D). Mortgage Backed: 7(D)(i). Agency, 7(D)(ii). Non-Agency, 7(D)(iii) Stripped IO, 7(D)(iv) Stripped PO; 7(E). Deferred Equity; 7(F). Exchangeable; 7(G). Metal Linked/Backed/Collateralized; 7(H). Commodities Linked/Backed/Collateraled; 7(I). Serial; 7(J). Sinking; 7(K). Junk; 7(L). Prime; 7(M). Subprime; 7(N). Tigers, TIPS; 7(O). Paid In Kind (PIK); 7(P). TBAs; 7(Q). Catastrophe; 7(R). Municipal; 8. Notes: 8(A). Exchange Traded, 8(B). Exchangeable, 8(C). Tax Anticipation, 8(D). Litigation Anticipation; 9. Bills; 10. Certificate of Deposit; 11. Collateral; 12. REPO (Open, Term); 13. CMO; 14. CDO; 15. MBS; 16. Litigation Recovery; 17. Equity Linked Eurobond; 18. Certificates; 19. Money Market; 20. Catastrophe; 21. Weather; and, 22. Any debt instrument.

II. OPTIONS: 1. On Stocks, Commodities, Metals; 2. On Bonds, Notes; 3. On FX; 4. On Futures; 5. On a Leap Adjusted Index or Indices; 6. Deferred Strike; 7. FLEX; 8. LEAPS; 9. Puts; 10. Calls; 11. Expirationless; 12. Exotic (Down and Out, Up and Out, Down and In, Up and In, Barrier); 13. Straddles; 14. Quanto; 15. Volatility Index (VIX); 16. Volatility; and, 17. Any option

III. COMMODITIES: 1. Crude Oil; 2. Gas; 3. Heating Oil; 4. Pork Bellies; 5. Orange Juice; 6. Cocoa; 7. Natural Gas; 8. Coffee; 9. Wheat; 10. Live Cattle; 11. Gasoline; 12. Soybeans; 13. Corn; 14. Cotton; 15. Hogs; 16. Grain; 17. CRB Index and its components; and, 18. Any Commodity Grown Under the Sun.

IV. CONTRACT FOR DIFFERENCE (CFD)

V. CREDIT DERIVATIVES: 1. Credit Default SWAPS (Single Names, Index, Indices); 2. Interest Only SWAPS; 3. Principal Only SWAPS; 4. Index Based; 5. Non-Index Based; 6. Market; and, 7. Any Credit Derivative.

VI. CURRENCY (FOREX): 1. Spot; 2. FX; 3. FX Forward; 4. FX SWAPS; 5. Overnight; 6. Cross Currency; and, 7. Any Currency.

VII. EQUITY: 1. Equity; 2. Preferred Stock; 3. Convertible Stock; 4. Warrants; 5. Debenture; 6. Private; 7. Exchange Traded; 8. Non-Traded; 9. Rights (Offering); 10. Tracking Stock; 11. Depository Shares or Receipts; 12. Certificates; 13. Index Participation Notes; 14. Index Shares; 15. Trust: 15(A). Grantor, 15(B). Unit Investment, 15(C). Business, 15(D). UCITS, UCITS II, UCITS III, UCITS IV; and, 16. Any Equity.

VIII. MUTUAL FUNDS: 1. Exchange Traded (Open Ended or Closed End); 2. Non Exchange Traded; 3. Closed End; 4. Interval Funds; 5. Actively Managed; 6. Passively Managed; 7. Commodity Pool; 8. Depository Receipt; and, 9. Any Mutual Fund.

IX. DERIVATIVE: 1. Futures (Short, Long); 2. Options; 3. Swaps; 4. CAPS, Floors, Collars; 5. Any Security Whose Value is Derived from Another Security; and, 6. Any Derivative.

X. INSURANCE PRODUCTS: 1. Annuities (Fixed, Variable); 2. Mortgage Certificates; 3. Investment Contracts; 4. Life; and, 5. Any Insurance Product.

XI. SWAPS: 1. Total Return Swaps; 2. Equity Swaps; 3. Variance Swaps; 4. FX; 5. Commodity; 6. Rollercoaster; 7. Asset; 8. Debt for Equity; 9. Interest Rate; 10. Credit Default; 11. Basis; 12. Swaptions; 13. Ratchet; and, 14. Any swap.

XII. STRUCTURED INVESTMENTS: 1. Rates Linked Notes/CD's; 2. Convertibles; 3. Reverse Convertibles; 4. Linked Notes; 5. Interest Rate; 6. Equity; 7. FX/Commodities/Options; 8. Others, including: 8(A). CMS Floaters, 8(B) Callable Step Coupon Notes, Callable Capped and/or Floored Floaters, 8(C). Stepped Cap/Floor Floater Notes, 8(D). Stepped Spread Callable Floater, 8(E). Inverse Floater Notes, 8(F). Deleveraged & Leveraged Floater Notes, 8(G). Dual-Index Notes (Steepeners), 8(H). Floater with a Curve Cap, 8(I). Flip-Flops (Switch Coupon Bonds), 8(J). Minimum or Maximum of, 8(K). Range Accrual Notes, 8(L). Spread Range Accrual Notes, 8(M). Dual Range Accruals Notes, 8(N). Multi-Range Accrual Notes, 8(O). Countdown Range Accrual Notes, 8(P). Digital Range Notes, 8(Q). Ratchet Floaters, 8(R). Inverse Ratchet Floaters (Snowballs), 8(S). Snowbear Notes, 8(T). Ratchet Range Accruals, 8(U). Inflation Linked Notes, 8(V). Zero Coupon Accreting as a Structured Coupon, 8(W). Target Redemption Notes (TARN), 8(X). Volatility/Absolute Value Notes, 8(Y). Credit Linked Notes, 8(Z). Index Amortization Notes (IAN), 8(AA). Power Reversal Dual Note, 8(AB). Total Return; and, 9. Any Structured Investment.

XIII. HYBRID SECURITY: 1. Those Containing Characteristics of More Than One Security (For Example Equity and Debt); and 2. Any Hybrid Security.

XIV. LOANS: 1. Auto; 2. Credit Card; 3. Line of Credit; 4. Corporate; 5. Revolver; and, 6. Any Loan.

XV. INDEX BASED: 1. Art; 2. Standard and Poors Indices; 3. Russell Indices; 4. Dow Jones Indices; 5. MSCI; 6. Postal Stamps; 7. Wine; 8. Coins; 9. Collectibles; 10. Performance of Hedge Funds; 11. Initial Public Offering; 12. Economic Indicators; 13. Interbank Rate, including LIBOR or Equivalent of another Country; 14. Interest Rate; 15. Default Rate; 16. Spread Between Indexes, including TED Spread; 16. Volatility; 17. Oil Tanker Prices; 18. Patent; 19. Patent Portfolio; 20. Real Estate; 21. Constant Maturity Total Return; and, 22. Any Index.

XVI. INVESTIBLE INDICES

XVII. NON INVESTABLE INDICES

XVIII. INDEX BASED

XIX. METALS: 1. Gold; 2. Silver; 3. Aluminum; 4. Uranium; 5. Rare Earth; 6. Lithium; 7. Copper; 8. Lead; 9. Nickel; 10. Zinc; 11. Steel; 12. Platinum; 13. Palladium; 14. Cobalt; 15. Molybdenum; and, 16. Other Metals or Combinations of Metals included in the Periodic Table.

XXI. ENERGY: 1. Electricity; 2. Nuclear Power; 3. Thorium; 4. Solar; 5. Wind; 6. Ocean Waves; and, 7. Thermal

XXII. INVESTABLE ASSETS

XXIII. NON-INVESTABLE ASSETS

XXIV. YIELD CURVE: 1. Steepner; 2. Flatner; 3. All of the Above—Either OTC or Non-OTC; and, 4. All of the Above—Either with Contango or Without Contango.

APPENDIX B

Provided below are examples of various embodiments of an exchange traded product that transforms into one or more separate exchange traded products on a user defined redemption basis. Each item should be read either independently or in combination with any other item. Further, the opposite of each item is also reserved as a possible embodiment.

I. Structure: A. Exchange Traded (See Appendix A for examples); B. Non-Exchange Traded (See Appendix A for examples); and, C. Combination of exchange traded and non-exchange traded (for example, security XX is exchange traded and security XXA and/or security XXB are not exchange traded).

II. Portfolio Management: A. Active (or semi-active); B. Passive (or semi-passive); and, C. Any type of portfolio management.

III. Portfolio Transparency: A. Full; B. Partial; and, C. Timing of display: Delayed, real-time, daily, user defined frequency.

IV. Portfolio Redemption Frequency: A. Daily; B. More frequently than daily (e.g. intra-day, hourly or real-time); and, C. Less frequently than daily (e.g. Multi-daily, weekly, monthly, quarterly, yearly).

Portfolio Distribution Type: A. Mandatory; B. Partial Mandatory; and, C. Strategy based (separately or in combination with a mandatory, non mandatory or partially mandatory distribution methodology).

Weighing of an underlying index or benchmark, portfolio or leverage: A. User defined; B. Equal price weighted; C. Capitalization weighted; D. Geometrically weighted; E. Market value weighted; F. Market share weighted; G. Market capitalization weighted; H. Attribute weighted; I. Custom weighted; J. Revenue weighted; K. Factor weighted; L. Un-weighted; M. Accounting based data weighted (including but not limited to cash flow, book value, debt rating); N. Leverage weighted; and, O. Any type of weighting.

Portfolio Holdings: A. Investable universe of securities, see Appendix A above for additional examples; B. Synthetic securities; C. VIX Index, VIX options; D. CBOES; and, E. Any holding.

Creation and/or Redemption Basket: A. Two securities; B. More or less than two securities; C. A general ledger accounting treatment.

Leverage: A. Any Inverse performance (e.g. −50, 100%, −200%, −300%); B. Any Multiple (or fraction) of performance (e.g. 50, 150%, 200%, 250%, 300%); C. Leveraged according to predefined formula; D. Non leveraged with a specific distribution based methodology; E. Greater than benchmark or index; F. Less than benchmark or index; G. Non price path dependent; H. No compounding; I. Utilizing a non-exponential formula; and, J. Any type of leverage.

Riskiness: A. Greek risk (e.g., alpha, beta, gamma, delta, theta, lambda, rho); B. Value at risk; C. Sharpe ratio; D. Systemic risk; E. Credit or Default risk; F. Country risk; G. Foreign-Exchange risk; H. Political risk; I. Market risk; J. Interest rate risk; K. Risk/reward ratio; L. Duration; and, M. Any risk measure.

Trading Strategies used in conjunction with an embodiment: A. Portfolio Optimization; B. Convertible Arbitrage; C. Long/short; D. 130/30; E. Relative Value; F. Fundamental Pairs trading; G. Statistical Arbitrage; H. Deep value; I. Global Macro; J. Directional; K. Event-driven; L. Miscellaneous; M. Merger arbitrage; N. Special situation; O. Risk Arbitrage; P. Distressed; Q. Equity Market Neutral; R. Emerging Market; S. Fixed income arbitrage; T. Sector; U. Growth; V. Value; W. Volatility; X. VWAP (volume weighted average price); Y. Technical Analysis; Z. ETF Arbitrage wherein, as an ETF arbitrage mechanism example: if the aggregate price of the ETF's Portfolio Securities is higher than the price of a Creation Unit of such ETF's units/shares, an institutional investor will tender such Creation Unit for redemption and receive the higher-priced underlying Portfolio Securities. Alternatively, if the aggregate price of the ETF's Portfolio Securities is lower than the price of a Creation Unit of such ETF's units/shares, an institutional investor will deposit the basket of Portfolio Securities and receive a Creation Unit.

Class of Shares: A. Single; and, B. Multiple.

Securities Holdings as percentage of a creation unit or creation unit basket (or redemption unit or redemption basket): A. 100%; B. Less than 100%; C. Greater or less than 50%; and, D. Substantially equivalent to a target percentage.

Accounting system: A. Subaccounts; B. Pooled accounts; C. Managed accounts; D. Unmanaged accounts; E. Computerized; F. General Ledger (real-time or batch); and, G. Any type of accounting system by itself.

Asset Management System: Any application system involved in the creation and/or management of an exchange or non exchange traded product.

What is claimed is:

1. A system for creating an exchange traded product having a daily exchange feature, the system comprising:
a computer memory comprising a set of defined criteria and a computer database containing data representing characteristics of a plurality of securities;
a processor for calculating at least an end of day weighting ratio derived from the securities based upon market capitalization contained in the database, the processor weighting the selected securities within the exchange traded product based on a set of defined weighting ratio criteria;
wherein the exchange traded product is configured for trading of shares of the exchange traded product at a real-time determined price of the shares related to an underlying price of each of the selected securities comprising the exchange traded product and related to the weightings of the selected securities; and,
wherein the exchange traded product exchanges its market capitalization on at least a daily basis into two separate securities based upon a defined weighting ratio, the two separate securities comprising a majority of the market capitalization of the exchange traded product.

2. The system of claim 1 wherein the two separate securities have a combined weighted average leverage that is substantially fixed and constant over at least a day.

3. The system of claim 1 wherein the two separate securities have a combined non-price path dependent leverage over more than one day.

4. The system of claim 1 wherein the exchange traded product does not provide leverage drift over time.

5. The system of claim 1 wherein the two separate securities combined are not subject to a compounding of daily leverage through rebalancing.

6. The system of claim 1 wherein a clearing corporation flags a security identifier of one or both of the two separate securities so they can only be sold after listing on an exchange.

7. The system of claim 6 wherein the security identifier is either ISIN or the CUSIP.

8. The system of claim 1 wherein the two related securities have a class of shares.

9. The system of claim 1 wherein a non exchange traded mutual fund purchases the two related securities and provides its investors with a non price path dependent leveraged return.

10. The system of claim 1 further comprising an accounting system for calculating financial statements for dissemination to owner of the shares.

11. The system of claim 1 wherein the processor calculates a net asset value of the exchange traded product.

12. The system of claim 1 wherein the exchange traded product comprises of at least one product from a group consisting of: puts and calls, futures, caps and floors, total return swaps, collars, warrants, equity swaps, options and knock-out options.

13. The system of claim 1 wherein the exchange traded product comprises at least one product structure from a group consisting of: an Exchange Traded Fund, an Exchange Traded Note, a Grantor Trust, a Unit Investment Trust, a Business Trust, a Closed End Fund, an Open End Fund, a Mutual Fund, a partnership, a Trust, a special purpose vehicle.

14. The system of claim 1 wherein the exchange traded product is a derivative.

15. The system of claim 1 wherein the exchange traded product is not a derivative.

16. The system of claim 1 wherein the plurality of securities is two or less.

17. The system of claim 1 wherein the securities within the leveraged portfolio satisfy a performance criteria.

18. The system of claim 17 wherein the securities within the portfolio have an expected future performance return greater than a group of securities comprising a benchmark on a daily basis.

19. The system of claim 18 wherein the leveraged portfolio provides a return greater than the group of securities comprising the benchmark on a daily basis.

20. The system of claim 19 wherein the benchmark is an Index.

21. The system of claim 19 wherein the benchmark is not an Index.

22. The system of claim 18 wherein the expected future return is a whole or fractional multiple of the benchmark return.

23. The system of claim 18 wherein the expected future return is a whole or fractional inverse multiple of the benchmark return.

24. A system for creating a non-exchange traded product having a daily exchange feature, the system comprising:
a computer memory comprising a set of defined criteria and a computer database containing data representing characteristics of a plurality of securities;
a processor for calculating at least an end of day weighting ratio derived from the securities based upon market capitalization contained in the database, the processor weighting the selected securities within the exchange traded product based on a set of defined weighting ratio criteria;
wherein the non-exchange traded product is configured for trading of shares of the non-exchange traded product at a determined price of the shares related to the underlying price of each of the selected securities comprising the non-exchange traded product and related to the respective weightings of the selected securities; and,
wherein the non-exchange traded product exchanges its market capitalization on at least a daily basis into two related securities based upon a defined weighting ratio, the two related securities comprising a majority of the market capitalization of the exchange traded product.

25. The system of claim 24 wherein the non-exchange traded product comprises at least one product structure from a group consisting of: a Mutual Fund, a Note, a Grantor Trust, a Unit Investment Trust, a Business Trust, a Closed End Fund, an Open End Fund, a Fund, a partnership, a Trust, a special purpose vehicle.

26. A system for creating a leveraged exchange traded product having a daily exchange feature, the system comprising:
a computer memory comprising a set of defined criteria and a computer database containing data representing characteristics of a plurality of securities;
a processor for calculating at least an end of day weighting ratio derived from the securities based upon the market capitalization contained in the database, the processor weighting the selected securities within the exchange traded product based on a set of defined weighting ratio criteria;
wherein the leveraged exchange traded product is configured for trading of shares of the exchange traded product at a determined price of the shares related to the underlying price of each of the selected securities comprising the leveraged exchange traded product and related to the respective weightings of the selected securities; and,
wherein the leveraged exchange traded product exchanges its market capitalization on at least a daily basis into two related securities based upon a defined weighting ratio, the two related securities comprising the majority of the market capitalization of the leveraged exchange traded product.

27. The system of claim 26 further comprising valuing components securities temporally decomposed, the components comprising a substantial majority of the market capitalization of the exchange traded product.

28. The system of claim 27 wherein the substantial majority is at least 95%.

29. A process for administering a transformation of an exchange traded single product into two or more separate exchange traded single products on a daily basis, the process comprising the steps of:
(a) recording issuance of shares by a single exchange traded product bought from and redeemed with the single exchange traded product at a net asset value on a daily basis;
(b) recording a daily automatic redemption of the majority of shares by the single exchange traded product that are listed for trading on a securities exchange and that are bought and sold at negotiated market prices;
(c) calculating a leverage weighting solution on at least a daily basis;
(d) recording issuance of shares by the second and third exchange traded product comprising a combined market capitalization substantially equivalent to the market capitalization of the single exchange traded product and which incorporates a leverage weighting solution; and,
(e) maintaining account data of the outstanding shares of each exchange traded product, wherein an owner of any share has an undivided interest in one or more of the exchange traded products.

30. The process of claim 29 wherein shares that are bought and sold at negotiated market prices are exchange-traded shares, and wherein an investor purchases or sells the exchange-traded shares on the secondary market through a broker, the process further comprising the steps of: executing the purchase or selling of the exchange-traded shares, the account data of the investor being updated in the one or more computers to reflect the new number of shares held by the investor.

31. The process of claim 30 further comprising: purchasing or selling the exchange-traded shares from or to a market maker on behalf of the investor to fulfill the investor's purchase or sell order.

32. The process of claim 29 wherein there are a plurality of shareholders and the account data includes an account for each shareholder.

33. The process of claim 29 wherein a shareholder acquires the exchange-traded shares by requesting conversion of a designated number or dollar value of shares belonging to the one or more classes of shares bought from and redeemed with the single exchange traded product at a net asset value for a monetarily equivalent number of shares of the one or more classes of shares that are exchange-traded shares of the single exchange traded product, the process further comprising: implementing the requests for conversion, the account data being updated to reflect the new number of shares of each type.

34. The process of claim 29 wherein an authorized participant purchases the exchange-traded shares directly from the single exchange traded product in exchange for a basket of securities of generally equivalent monetary value, wherein a direct purchase requires a purchase of a predetermined number of exchange-traded shares, the process further comprising:
implementing direct purchase requests, the account data being updated to include the newly purchased shares.

35. The process of claim 29 wherein the single exchange traded product is an open-end fund.

36. The process of claim 29 wherein the single exchange traded product is a closed-end fund.

37. The process of claim 29 wherein the single exchange traded product is a trust.

38. The process of claim 29 wherein the exchange-traded shares are publicly listed and traded.

39. The process of claim 29 wherein the single exchange traded product has an investment objective of tracking a specific benchmark index of securities.

40. An apparatus valuing two component securities temporally decomposed from a single investable security, the apparatus comprising:
an input device converting input leverage data representing the single investable security into input signals representing the input data;
a computer having a processor, the processor connected to receive the input signals, the processor programmed to change the input signals to produce modified signals representing a separate market-based valuation of each of a plurality of components temporally decomposed from the single investable security, the components including a first component security containing a starting leverage factor less than a target leverage amount and a second component security containing a starting leverage factor greater than a target leverage amount; and,
an output device connected to the processor converting the modified signals into documentation including the respective valuation, price, market capitalization and leverage weighting factor of each of the components.

41. The apparatus of claim 40, wherein at least one of the valuations reflects that there is an investable entity for at least one of the components, the entity from a group comprising: an investment company, a grantor trust, a unit investment trust, a special purpose vehicle, an exchange traded note, an exchange traded fund.

42. The apparatus of claim 40, wherein the temporal state is one of a group, the group comprising: intra-day, real-time, end of day, start of day, weekly, monthly, yearly, multi-yearly.

43. The apparatus of claim 40, wherein the leverage weighting factor of the two component securities containing the decomposed market capitalization of the single investable security is derived at least in part by (Target Leverage-Current leverage component security number two) Divided by (Current Leverage component security one-Current Leverage component security two).

44. The apparatus of claim 40, wherein the two component securities are replaced with two new component securities when neither of the original component securities has a leveraged factor greater than the single investable security.

45. A system of buying or selling in combination two securities that have a linked stop loss feature comprising:
a first security providing a price derived leverage amount below a target amount;
a second security providing a price derived leverage amount above a target amount,
wherein the two securities comprising a daily creation or redemption basket from a single ticker exchange traded fund, and,
wherein the two securities are capable of providing the same leverage as the single ticket exchange traded fund on a continuous non-disrupted time period.

46. The system claim 45 wherein the single ticker security and the combined two securities provide a continuous non-price path dependent constant leverage return over any time period.

47. A method of distributing closing shareholder positions and ownership records of a first leveraged exchange traded fund into a pair of two separate products on a daily basis, comprising the steps of:
notifying a custodian of security position changes;
notifying a transfer agent of shareholder record changes; and
distributing a closing market capitalization of the first fund to shareholders of record of the first fund for securities in the pair of said second and third products that provide in combination a non-price path dependent return with no leverage drift or compounding.

48. The method of claim 47 wherein the second and third products are exchanged traded.

49. The method of claim 47 wherein the second and third products are not exchange traded.

50. The method of claim 47 wherein the pair of products meets a combined weighted average leverage criteria.

51. The method of claim 50 wherein the leverage criteria is to provide the same leverage as the first fund.

52. A system for creating a leveraged exchange traded product having a daily allocation and distribution feature, the system comprising:
a computer memory comprising a set of defined criteria and a computer database containing data representing characteristics of a plurality of securities;
a processor for calculating at least an end of day weighting ratio derived from the securities based upon the market capitalization contained in the database, the processor weighting the selected securities within the exchange traded product based on a set of defined weighting ratio criteria;
wherein the leveraged exchange traded product is configured for trading of shares of the exchange traded product at a determined price of the shares related to the underlying price of each of the selected securities comprising the leveraged exchange traded product and related to the respective weightings of the selected securities; and,
wherein the leveraged exchange traded product allocates and distributes its market capitalization on at least a daily basis into two related securities based upon a defined weighting ratio, the two related securities comprising the majority of the market capitalization of the leveraged exchange traded product.

53. The system of claim 52 further comprising the step of employing a computerized asset management program to determine a closing market capitalization level of the first product;

54. The system of claim 52 further comprising the step of distributing the closing market capitalization of the first fund to the shareholders of record of the first fund for securities in the pair of second and third products that provide in combination a non price path dependent return with no leverage drift or compounding.

55. The system of claim 52 wherein the distribution occurs in conjunction with a corporate action, the corporate action including at least one of a group, the group comprising: a creation event, a redemption event, a stock split, a dividend, a spinoff, a material event.

56. The system of claim 52 where not all of the market capitalization is distributed on a daily basis, the non distributed market capitalization comprising at least a portion of the opening market capitalization of the product on a T+1 basis.

57. The system of claim 52 where not all of the market capitalization is allocated and distributed on a daily basis, the residual market capitalization comprising a portion of the opening market capitalization of the product on at least a T+1 basis.

58. The system of claim 52 wherein the leveraged product is a fund of funds.

59. The system of claim 58 wherein the fund of funds provides an opportunity to receive a leveraged return of at least twice the daily price performance of a benchmark.

60. The system of claim 52 wherein the allocation and distribution of at least a portion of the market capitalization of the exchange traded product occurs more frequently than once a day.

61. A computer implemented system for exchanging shares in an exchange traded product, the system comprising:
a display for displaying data representing shares of an exchange traded product comprising a leveraged portfolio of securities satisfying market capitalization criteria, the securities within the portfolio being weighted and having an expected return that is both greater than, and less than, the desired expected return of the exchange traded product, wherein the leveraged exchange traded product is configured for trading shares of the leveraged exchange traded product at a determined price of the shares related to the underlying price of each of the selected securities comprising the leveraged exchange traded product and related to the respective weightings of the selected securities; and,
an exchange computer for processing the exchange of the shares at a price related to the price of the securities within the leveraged portfolio.

62. A computer implemented system for exchanging shares in a leveraged exchange traded product, the product incorporating both a minimum and maximum threshold level of eligible closing end of day market capitalization to be transferred daily to a predetermined number of related securities having a similar legal structure to the product, the system comprising:
a display for displaying data representing shares of an exchange traded product comprising a leveraged portfolio of securities satisfying market capitalization and leverage criteria, one or more of the securities within the portfolio being weighted and having an expected return that is both greater than, and or less than, the desired expected return of the exchange traded product, wherein the leveraged exchange traded product is configured for trading shares of the leveraged exchange traded product at a determined price of the shares related to the underlying price of each of the selected securities comprising the leveraged exchange traded product and related to the respective weightings of the selected securities; and,
an exchange computer for processing the exchange of the shares at a price related to the price of the securities within the leveraged portfolio.

63. The system of claim 62 wherein the eligible closing end of day market capitalization does not include a minimum maintenance level of assets to allow the product to continue trading.

64. The system of claim 62 wherein the eligible closing end of day market capitalization does not comprise seed capital.

65. The system of claim 62 wherein the legal structure for all products is a fund.

66. The system of claim 62 wherein the leverage criteria is to provide a non price path dependent leverage return with no compounding or leverage drift over more than one day.

67. The system of claim 62 wherein the legal structure for all products is not a fund.

68. The system of claim 62 wherein the legal structure for all products is a grantor trust.

69. The system of claim 62 wherein the legal structure for one or more of the products comprises one or more of a group, the group consisting of:
a unit investment trust, an exchange traded note, a closed end fund, an open end fund, a special purpose vehicle, a business trust, a derivative.

70. The system of claim 62 wherein a linked derivative is listed for trading on the exchange.

71. The system of claim 70 wherein the derivative is bought and sold electronically on the exchange.

72. The system of claim 62 wherein a marketplace other than an exchange provides for the placing of a buy or sell transaction at, near or related to the processed prices.

73. The system of claim 62 wherein the predetermined number of securities does not exceed five.

74. A system for creating a leveraged exchange traded product having a mandatory daily redemption feature, the system comprising:
a computer memory comprising a set of defined criteria and a computer database containing data representing characteristics of a plurality of securities;
a processor for calculating at least an end of day weighting and leverage ratio derived from the securities based upon the market capitalization contained in the database, the processor weighting the selected securities within the exchange traded product based on a set of defined weighting ratio criteria;
wherein the leveraged exchange traded product is configured for trading of shares of the exchange traded product at a determined price of the shares related to the underlying price of each of the selected securities comprising the leveraged exchange traded product and related to the respective weightings of the selected securities; and,
wherein the leveraged exchange traded product redeems its market capitalization on at least a daily basis into a predetermined pair of related securities based upon a defined weighting and leverage ratio, the pair of related securities comprising the majority of the market capitalization of the leveraged exchange traded product and having the same legal structure as the product.

75. The system of claim 74 wherein the product incorporates both a minimum and maximum threshold level of eligible closing end of day market capitalization to be transferred daily.

76. The system of claim 74 wherein the product does not redeem 100% of its closing end of day market capitalization on a daily basis.

77. The system of claim 74 wherein the product does not mature on a daily basis.

78. The system of claim 74 wherein the product is not an exchange traded note.

79. The system of claim 74 wherein the redeemed market capitalization provides a non price path dependent return to its investors

80. The system of claim 74 wherein the legal structure comprises one or more of a group, the group consisting of: a grantor trust, an open end fund, a closed end fund, a unit investment trust, a special purpose vehicle, a business trust, a derivative.

81. The system of claim 74 wherein one or more of the products are listed on an exchange.

82. The system of claim 74 wherein one or more of the products are not listed on an exchange.

83. The system of claim 74 wherein the leverage and weighting ratios related to the pair of securities are calculated and disseminated during the day.

84. The system of claim 74 wherein the products are bought and sold electronically through a broker order execution system.

85. The system of claim 84 wherein the broker order execution system provides the ability to open and close an existing position by referencing an intra-day weighting or leverage ratio related to the pair of related securities.

86. The system of claim 85 wherein the position is partially closed.
